(19) United States
(12) Patent Application Publication
(10) Pub. No.: US 2024/0307786 A1
(43) Pub. Date: Sep. 19, 2024

(54) TURN-BASED BATTLE INTERFACE DISPLAY METHOD AND APPARATUS, DEVICE, AND MEDIUM

(71) Applicant: Tencent Technology (Shenzhen) Company Limited, Shenzhen (CN)

(72) Inventor: Peng LU, Shenzhen (CN)

(73) Assignee: Tencent Technology (Shenzhen) Company Limited, Shenzhen (CN)

(21) Appl. No.: 18/673,019

(22) Filed: May 23, 2024

Related U.S. Application Data
(63) Continuation of application No. PCT/CN2023/099526, filed on Jun. 9, 2023.

(30) Foreign Application Priority Data
Aug. 19, 2022 (CN) 202211001670.6

(51) Int. Cl. A63F 13/822; A63F 13/825

(52) U.S. Cl. CPC A63F 13/822; A63F 13/825

(57) ABSTRACT

In a turn-based battle interface display method, a scene picture corresponding to a master virtual character located in a world environment is displayed. In response to a trigger event for a turn-based battle, a scene picture corresponding to a pet virtual character located in a battle environment is displayed. The pet virtual character is a virtual character released by the master virtual character and the battle map is a partial environment in the world environment. The pet virtual character is controlled to cast a virtual skill on the battle map. At least one of skill strength, a skill effect, and a visual effect of the virtual skill is associated with an environmental factor of the battle map.

### RELATED APPLICATIONS

The present application is a continuation of International Application No. PCT/CN2023/099526, filed on Jun. 9, 2023, which claims priority to Chinese Patent Application No. 202211001670.6, filed on Aug. 19, 2022. The entire disclosures of the prior applications are hereby incorporated by reference.

### FIELD OF THE TECHNOLOGY

This disclosure relates to the field of virtual environments, including to a turn-based battle interface display method and apparatus, a device, and a medium.

### BACKGROUND OF THE DISCLOSURE

An open world game is a video game that supports a player in exploring in a game world to a higher degree. The open world game usually has a larger map range. There may be various battles when a player character explores in the game world. Different from a real-time battle mode, a turn-based battle mode focuses more on an order of rounds during a battle, and the player character can actively launch an attack only in a turn of the player character.

In the related art, before a turn-based battle between a player character and an opponent character, an independent battle space is developed, and internal environment of the battle space is preset. The characters of two camps battle against each other in the battle space, and return to an open world again after the battle ends.

However, the open world and the battle space of the turn-based battle are independent of each other, and there is a clear boundary between the battle space and the open world. In view of this, how to eliminate a sense of the boundary caused by the turn-based battle has become a technical problem urgently to be resolved.

### SUMMARY

This disclosure provides a turn-based battle interface display method and apparatus, a device, and a non-transitory computer-readable storage medium, which can help eliminate a sense of division between a world scene and a battle scene. Examples of technical solutions are as follows.

According to an aspect of this disclosure, a turn-based battle interface display method is provided. In the method, a scene picture corresponding to a master virtual character located in a world environment is displayed. In response to a trigger event for a turn-based battle, a scene picture corresponding to a pet virtual character located in a battle environment is displayed, the pet virtual character being a virtual character released by the master virtual character and the battle environment being a partial environment in the world environment. The pet virtual character is controlled to cast a virtual skill on the battle environment. At least one of skill strength, a skill effect, and a visual effect of the virtual skill is associated with an environmental factor of the battle environment.

According to an aspect of this disclosure further provides, a turn-based battle interface display apparatus, including processing circuitry configured to display a first scene picture corresponding to a master virtual character located in a world environment. The processing circuitry configured to display a second scene picture corresponding to a pet virtual character located in a battle environment in response to a trigger event for a turn-based battle. Wherein the pet virtual character being a virtual character released by the master virtual character and the battle environment being a partial environment of the world environment. The processing circuitry configured to control the pet virtual character to cast a virtual skill on the battle environment, wherein at least one of skill strength, a skill effect, or a visual effect of the virtual skill being associated with an environmental factor of the battle environment.

According to an aspect of this disclosure, a terminal device is provided, including a processor and a memory, the memory having a computer program stored therein, the computer program being loaded and executed by the processor to implement the turn-based battle interface display method as described above.

According to an aspect of this disclosure, a non-transitory computer-readable storage medium is provided, having computer program instructions stored therein, the computer program instructions being loaded and executed by a processor to perform the turn-based battle interface display method as described above.

According to an aspect of this disclosure, a computer program product is provided, the computer program product including computer instructions, the computer instructions being stored in a computer-readable storage medium. A processor of a computer device reads the computer instructions from the computer-readable storage medium, and executes the computer instructions, to cause the computer device to perform the turn-based battle interface display method provided in the foregoing aspects.

Examples of beneficial effects brought by the technical solutions provided in the aspects of this disclosure include the following:

The same piece of map data is shared by the battle map and the world map that are used in the turn-based battle, so that when the world scene is switched to the battle scene, the battle map can synchronize map data of the world map, thereby achieving consistency of the world map and the battle map, and eliminating the sense of division between the two. By using the method, a server or the terminal device only needs to maintain one piece of map data. This helps to save resources consumed by the server or the terminal device for storing and processing the map data.

In addition, in this solution, at least one of the skill strength, the skill effect, and the visual effect of the virtual skill is associated with the environmental factor, so that a cast effect of the virtual skill is enhanced or weakened under the influence of the environmental factor, to cause a player to think about a virtual skill cast method achieving more rewards, thereby enhancing a strategy property of the game. This further helps to increase a dimension pre-battle point selection. Before entering the turn-based battle, the player may select a battlefield that is beneficial to a camp of the player (and/or a battlefield that is not beneficial to an opponent), so that the pet virtual character can case a skill with greater power and a more gorgeous visual effect in the selected battlefield.

### BRIEF DESCRIPTION OF THE DRAWINGS

To describe the technical solutions in aspects of this disclosure more clearly, the following briefly describes the accompanying drawings. The accompanying drawings in the following description show only some aspects of this disclosure. Other aspects are within the scope of the present disclosure.

FIG. 1 is a schematic diagram of a scene picture of a world map according to an exemplary aspect.

FIG. 2 is a schematic diagram of switching a partial map to a battle map in a world map according to an exemplary aspect.

FIG. 3 is a structural block diagram of a computer system according to an exemplary aspect.

FIG. 4 is a flowchart of a turn-based battle interface display method according to an exemplary aspect.

FIG. 5 is a schematic diagram of an emotion effect according to an exemplary aspect.

FIG. 6 is a schematic diagram of a first affinity effect according to an exemplary aspect.

FIG. 7 is a schematic diagram of a second affinity effect according to an exemplary aspect.

FIG. 8 is a schematic diagram of a first conflict effect according to an exemplary aspect.

FIG. 9 is a schematic diagram of a second conflict effect according to an exemplary aspect.

FIG. 10 is a schematic diagram of a visual effect of a basic virtual skill of a pet virtual character according to an exemplary aspect.

FIG. 11 is a schematic diagram of a visual effect of a virtual skill according to an exemplary aspect.

FIG. 12 is a schematic diagram of a visual effect of a virtual skill according to an exemplary aspect.

FIG. 13 is a schematic diagram of a visual effect of a virtual skill according to an exemplary aspect.

FIG. 14 is a flowchart of a turn-based battle process according to an exemplary aspect.

FIG. 15 is a flowchart of a turn-based battle interface display method according to an exemplary aspect.

FIG. 16 is a flowchart of a turn-based battle interface display method according to an exemplary aspect.

FIG. 17 is a structural block diagram of a turn-based battle interface display apparatus according to an exemplary aspect.

FIG. 18 is a structural block diagram of a terminal device according to an exemplary aspect.

### DETAILED DESCRIPTION

“Several” mentioned in this specification means one or more, and “plurality of” means two or more. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive. The character “/” in this specification generally indicates an “or” relationship between the associated objects.

First, examples of terms in this disclosure are briefly introduced below.

Open world game: It is a game that supports one or more players in exploring in a game world to a higher degree, where the open world game usually has a larger map range. In this disclosure, a map in the open world game is a world map, for example a virtual environment or a world environment.

Turn-based battle: It is a battle mode in which both camps in the battle take turns to perform attack or defense or attribute improvement in an order of rounds. Different from a real-time battle mode, the turn-based battle focuses more on an order in the battle. One complete round in the turn-based battle may be a process in which both camps in the battle take turns to complete an active operation such as attack or defense or attribute improvement. Alternatively, one complete round may be a process in which a camp A completes an active operation such as attack or defense or attribute improvement. In this disclosure, a map in the turn-based battle is a battle map, for example a battle environment.

World map: It includes a plurality of land parcels. Each land parcel is a polygonal land parcel. The polygonal land parcel is in a shape of any one of a square, a rectangle, and a hexagon. For example, each land parcel is in a shape of a 50*50 cm square. Each land parcel has a respective surface morphology. The surface morphology includes grass, stone, water, and the like. In addition, the plurality of land parcels included in the world map may be land parcels of the same type, or may be a combination of land parcels of different types.

In an aspect, time of the open world game is controlled through a time of day (TOD) system. Under control of the TOD system, the world map may have time-related factors such as weather, day/night, four seasons, festivals, and the like.

Battle map: It is a partial map in the world map. When the turn-based battle is entered, the same piece of map data is used in a battle map in a battle scene and a world map in a world scene. A world server loads map data of the world map when the turn-based battle is not entered, and a battle server loads data of the partial map in the world map when the turn-based battle is entered, so that the same piece of map data is shared by the battle map and the partial map.

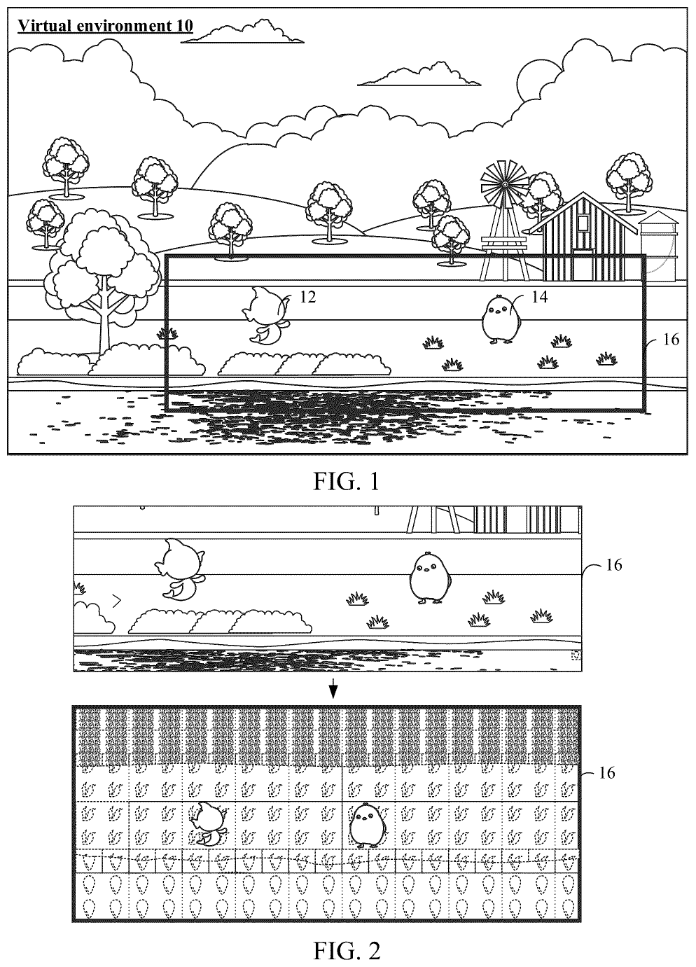

Refer to FIG. 1 and FIG. 2. In a virtual environment 10, when a pet virtual character 12 encounters a wild virtual character 14 at a location in the world map and enters a battle, one or more land parcels within a range centered on a reference position in the world map and determined by the pet virtual character 12 are determined as a battle map 16. The reference position is a position at which the pet virtual character 12 is located or a position that is suitable for the battle and that is closest to the pet virtual character 12. In some aspects, the battle map 16 includes all land parcels within a circular range with the reference position as a center and a predetermined length as a radius. In some aspects, the battle map 16 includes all land parcels within a rectangular range that is centered on the reference position and that has a predetermined length and width.

World scene and battle scene: The world scene is a scene corresponding to the world map. When the world scene is displayed in a user interface, one or more land parcels in the world map may be displayed in the user interface. For example, one or more land parcels in the world map in which a master virtual character or the pet virtual character is currently located, and some interface elements related to the displayed land parcels, the master virtual character, the pet virtual character, and the like are displayed in the user interface.

The battle scene is a scene corresponding to the battle map. When the battle scene is displayed in the user interface, the battle map may be displayed in the user interface, for example, all or some land parcels included in the battle map are displayed. For example, one or more land parcels in the battle map in which the master virtual character or the pet virtual character is currently located, and some interface elements related to the displayed land parcels, the master virtual character, the pet virtual character, and the like are displayed in the user interface.

The world scene and the battle scene may be switched to each other. For example, the world scene may be switched to the battle scene, or the battle scene may be switched to the world scene.

When the world scene and the battle scene are displayed, a virtual camera may shoot from different perspectives. For example, when the world scene is displayed, the virtual camera shoots the world scene from a perspective of the master virtual character (for example, a first-person perspective or a third-person perspective of the master virtual character), to obtain a display picture of the world scene. When the battle scene is displayed, the virtual camera shoots the battle scene from an intermediate perspective (for example, a position at which the virtual camera is located in the middle and obliquely above both camps), to obtain a display picture of the battle scene. In an aspect, in the world scene and the battle scene, in addition to different shooting perspectives, allowed user operations may also be different. For example, when the world scene is displayed, a user is allowed to manually adjust the perspective, and the user is allowed to control movement of the master virtual character or the pet virtual character. When the battle scene is displayed, the user is not allowed to manually adjust the perspective, and the user is not allowed to control movement and the like of the master virtual character or the pet virtual character. In this way, the user can distinguish between the world scene and the battle scene from perception. However, the same world map is shared by the world scene and the battle scene, and the battle map used in the battle scene is one or more land parcels in the world map. Therefore, switching between the world scene and the battle scene does not cause a strong sense of division, and switching is very smooth and natural.

Virtual environment: It is a virtual environment displayed (or provided) when an application program is run on a terminal. The virtual environment may be a simulated environment of a real world, or may be a semi-simulated semi-fictional environment, or may be an entirely fictional environment. A virtual world may be any one of a two-dimensional virtual world, a 2.5-dimensional virtual world, and a three-dimensional virtual world. This is not limited in this disclosure. In the following aspects, a description is made by using an example in which the virtual world is a three-dimensional virtual world.

Master virtual character: It is a movable object played by the player in the virtual world. The master virtual character may be a virtual person, a virtual animal, a cartoon person, or the like, for example, a person or an animal displayed in the three-dimensional virtual world. In an aspect, the master virtual character is a three-dimensional model created based on a skeletal animation technology. Each master virtual character has a respective shape and size in the three-dimensional virtual world, and occupies a part of space in the three-dimensional virtual world.

Pet virtual character: It is a movable object controlled through artificial intelligence (AI) in the virtual world. The pet virtual character may be a virtual creature, a virtual animal, a virtual monster, a virtual elf, a virtual pet, or the like, for example, a movable object in an animal or another form displayed in the three-dimensional virtual world. At least one of interaction operations such as capturing, raising, upgrading, and the like may be performed by the master virtual character on the pet virtual character. The pet virtual character may assist the master virtual character in performing at least one of interaction operations such as collecting, fighting, and changing land parcels.

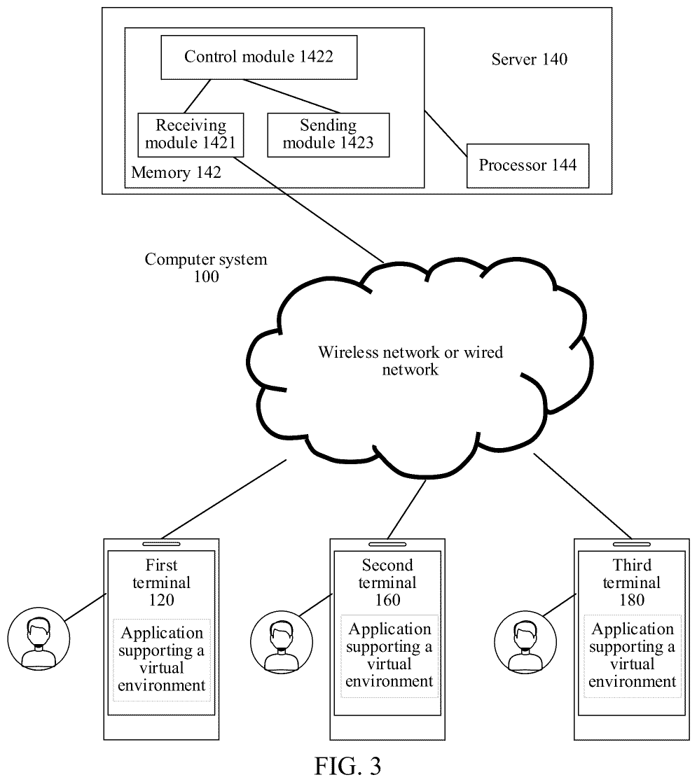

FIG. 3 is a structural block diagram of a computer system according to an exemplary aspect of this disclosure. The computer system 100 includes a first terminal 120, a server 140, a second terminal 160, and a third terminal 180.

In this aspect provided in this disclosure, the terminal may also be referred to as a terminal device. The terminal and the terminal device have the same meaning. For example, the “first terminal” may be referred to as a “first terminal device”.

An application supporting a virtual environment is installed and run on the first terminal 120. The application may be any one of a three-dimensional map application, a virtual reality (VR) application, an augmented reality (AR) application, an open world game application, an RPG application, a turn-based game application, a turn-based RPG application. The first terminal 120 is a terminal used by a first user, the first user uses the first terminal 120 to control a first virtual character in the virtual environment to perform motion. The first virtual character is regarded as a master virtual character. The motion includes but is not limited to at least one of adjusting a body posture, walking, running, jumping, cycling, driving, aiming, picking up, capturing a pet virtual character, controlling a pet virtual character, raising a pet virtual character, using a pet virtual character to pick, using a pet virtual character to perform a battle, and attack another virtual character. For example, the first virtual character is a first virtual character, for example, a simulated person object or a cartoon person object. For example, the first user controls, through a UI control in a virtual environment picture, the first virtual character to perform motion, and to be specific, the first user controls, through the UI control in the virtual environment picture, the first virtual character to throw the pet virtual character. The first terminal 120 is connected to the server 140 through a wireless network or a wired network.

The server 140 includes at least one of one server, a plurality of servers, a cloud computing platform, and a virtualization center. For example, the server 140 includes a processor 144 and a memory 142. The memory 142 includes a receiving module 1421, a control module 1422, and a sending module 1423. The receiving module 1421 is configured to receive request sent by a client, for example, a request for determining a position of an opponent virtual character. The control module 1422 is configured to control rendering on the virtual environment picture. The sending module 1423 is configured to send a response to the client, for example, send a position of the opponent virtual character to the client. The server 140 is configured to provide a backend service for an application supporting a three-dimensional virtual environment. In some aspects, the server 140 is responsible for primary computing work, and the first terminal 120, the second terminal 160, and the third terminal 180 are responsible for secondary computing work. Alternatively, the server 140 is responsible for secondary computing work, and the first terminal 120, the second terminal 160, and the third terminal 180 are responsible for primary computing work. Alternatively, the server 140, the first terminal 120, the second terminal 160, and the third terminal 180 perform collaborative computing by using a distributed computing architecture among each other.

An application supporting a virtual environment is installed and run on the second terminal 160. The second terminal 160 is a terminal used by a second user. The second user uses the second terminal 160 to control a second virtual character located in the virtual environment to perform motion. The second virtual character may also be regarded as a master virtual character. An application supporting a virtual environment is installed and run on the third terminal 180. The third terminal 180 is a terminal used by a third user. The third user uses the third terminal 180 to control a third virtual character located in the virtual environment to perform motion. The third virtual character may also be regarded as a master virtual character.

In an aspect, the first virtual character, the second virtual character, and the third virtual character are located in the same virtual environment. The first virtual character, the second virtual character, and the third virtual character belong to different camps, or the first virtual character, the second virtual character, and the third virtual character belong to the same camp.

In an aspect, the applications installed on the first terminal 120, the second terminal 160, and the third terminal 180 are the same, or the applications installed on the three terminals are applications of the same type on different operating system platforms (such as Android or IOS). The first terminal 120 may be generally one of a plurality of terminals, the second terminal 160 may be generally one of a plurality of terminals, and the third terminal 180 may be generally one of a plurality of terminals. In this aspect, only the first terminal 120, the second terminal 160, and the third terminal 180 are used as an example for description. The first terminal 120, the second terminal 160, and the third terminal 180 are of the same or different device types. The device type includes at least one of a smartphone, a smartwatch, a smart television, a tablet computer, a wearable device, an in-vehicle terminal, an e-book reader, a Moving Picture Experts Group Audio Layer III (MP3) player, a Moving Picture Experts Group Audio Layer IV (MP4) player, a laptop, and a desktop computer. The following aspect is described by using an example in which the terminal includes a smartphone.

In the following, each master virtual character may be replaced with a first master virtual character controlled by the first user, and each pet virtual character may be replaced with a first pet virtual character corresponding to the first master virtual character.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

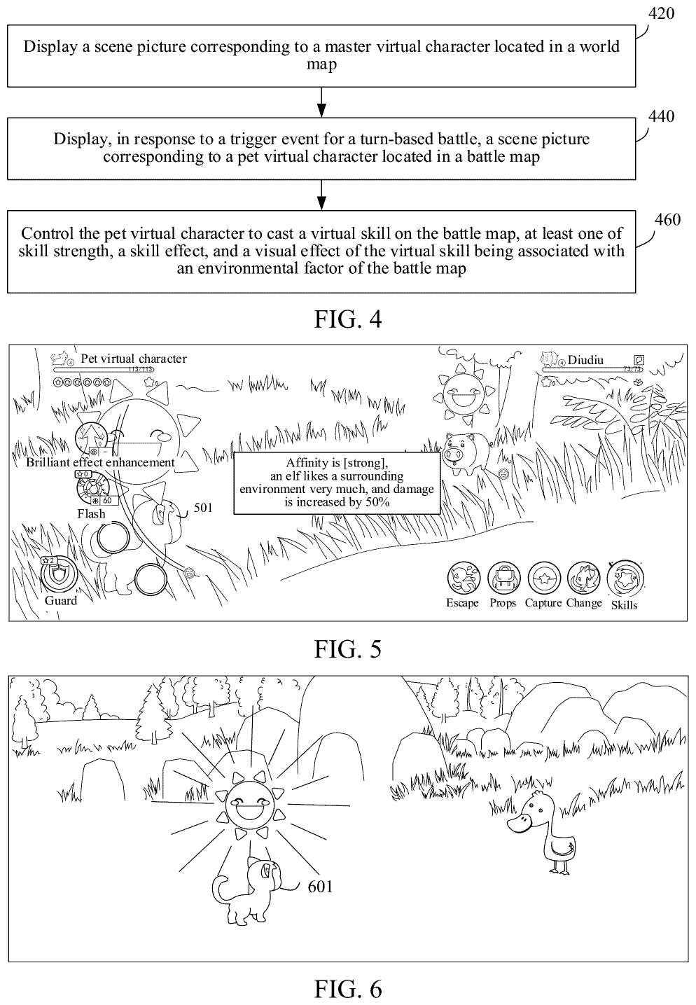

FIG. 4 is a flowchart of a turn-based battle interface display method according to an exemplary aspect of this disclosure. A description is made below by using an example in which the method is performed by a terminal (or an application supporting a virtual environment) shown in FIG. 3. The method includes:

Operation 420: Display a scene picture corresponding to a master virtual character located in a world map. In an example, a first scene picture corresponding to a master virtual character located in a world environment is displayed.

World map: It is a map configured for carrying motion performed by the master virtual character. In an aspect, the world map includes a castle, a market, a shopping street, a park, a forest, a hillside, a volcano, a port, a beach, and the like. The world map is a map network obtained by extending a plurality of scenic spots as key nodes. In an aspect, because the world map has more map resources for the player to explore, the world map may also be referred to as a “large world”.

Master virtual character: It is a movable object played by the player in the virtual world. Pet virtual character: It is a movable object controlled through artificial intelligence in the virtual world. In an aspect, the master virtual character includes at least one pet virtual character, and the master virtual character releases the pet virtual character by throwing a spherical virtual prop.

In an aspect, the pet virtual character can perform, in the virtual world, an interaction behavior on the master virtual character. For example, the interaction behavior includes: when the master virtual character feeds the pet virtual character food, jumping, by the pet virtual character, around the master virtual character, and asking the master virtual character for more food; picking up, by the pet virtual character, fruits in the virtual environment, and delivering the fruits to the master virtual character; breathing, by the pet virtual character, flames out when the master virtual character is to grill; racing, by the pet virtual character, against the master virtual character; and assisting or replacing, by the pet virtual character, the master virtual character to perform a battle.

In the foregoing examples, the pet virtual character serves as a companion of the master virtual character to accompany the master virtual character to explore. In an aspect, the pet virtual character and the master virtual character have a companion growth mechanism, and a level of the pet virtual character is affected by a level of the master virtual character. For example, the level of the pet virtual character cannot be higher than the level of the master virtual character.

Operation 440: Display, in response to a trigger event for a turn-based battle, a scene picture corresponding to a pet virtual character located in a battle map. In an example, in response to a trigger event for a turn-based battle, a second scene picture corresponding to a pet virtual character located in a battle environment is displayed. The pet virtual character may be a virtual character released by the master virtual character. The battle environment may be a partial environment of the world environment.

The trigger event for the turn-based battle is configured for triggering a turn-based battle of the pet virtual character. In an aspect, the trigger event for the turn-based battle includes but is not limited to the following implementations: 1. The master virtual character performs motion in the world map, and if the master virtual character or the pet virtual character breaks into a territory of a wild virtual character in the wild, a turn-based battle between the master virtual character and the wild virtual character is triggered. 2. The master virtual character performs motion in the world map, the terminal releases the pet virtual character in response that the master virtual character actively throws the spherical virtual prop including the pet virtual character to the wild virtual character, and if the pet virtual character finds that there is a wild virtual character around the pet virtual character, the master virtual character actively initiates a turn-based battle against the wild virtual character. 3. The first master virtual character encounters a second master virtual character in the world map, the first master virtual character makes a dialog with the second master virtual character, and the terminal starts a turn-based battle in response to an operation that is for performing the turn-based battle and that is agreed by both parties at the end of the dialog, where the first master virtual character is a master virtual character controlled by a first player; and the second master virtual character is a master virtual character controlled by a second player, or a non-player character (NPC) set in the game. 4. The first master virtual character encounters the second master virtual character in the world map, the second master virtual character initiates a surprise attack on the first master virtual character, and the first master virtual character is forced to enter a turn-based battle.

In an aspect, the terminal determines, in response to the trigger event for the turn-based battle, to perform the turn-based battle, and a user interface is switched from a scene picture in which the world map is displayed to a scene picture in which the battle map is displayed.

In an aspect, the terminal performs smooth transition between two scene pictures by playing an animation. In an aspect, content of the animation includes: throwing, by the master virtual character, the spherical virtual prop, and releasing the pet virtual character from the spherical virtual prop. In an aspect, the content of the animation includes a provocation picture of an opponent virtual character.

In an aspect, before entering the turn-based battle, the master virtual character has released the pet virtual character, and the pet virtual character and the master virtual character are located in the world map. In this case, the master virtual character may no longer need to release the pet virtual character after entering the turn-based battle. In another aspect, before entering the turn-based battle, the pet virtual character is not located in the world map. In this case, the master virtual character releases the pet virtual character after entering the turn-based battle.

After the turn-based battle is entered, the terminal displays the scene picture corresponding to the pet virtual character located in the battle map, where the battle map is a partial map in the world map. Refer to FIG. 2. An upper half part in FIG. 2 shows the partial map in the world map, and a lower half part in FIG. 2 shows the battle map. In an aspect, the world map includes a plurality of land parcels. The partial map in the world map has the same quantity of land parcels as the battle map, the partial map corresponds to land parcels included in the battle map, and environmental factors remain consistent.

In an aspect, the scene picture of the battle map includes the pet virtual character and the opponent virtual character. The opponent virtual character may be the second master virtual character controlled by the second player, or may be a second pet virtual character.

Operation 460: Control the pet virtual character to cast a virtual skill on the battle map, at least one of skill strength, a skill effect, and a visual effect of the virtual skill being associated with an environmental factor of the battle map. In an example, the pet virtual character is controlled to cast a virtual skill on the battle environment. At least one of skill strength, a skill effect, or a visual effect of the virtual skill may be associated with an environmental factor of the battle environment.

In some aspects, the virtual skill is a skill of the pet virtual character, and the pet virtual character can cast the virtual skill in the battle map. In an aspect, the pet virtual character has at least one virtual skill, and the terminal controls, in response to an operation on a skill control corresponding to a first virtual skill, the pet virtual character to cast the first virtual skill in the battle map.

In an aspect, the skill strength of the virtual skill is action strength of the virtual skill. For example, a virtual skill is configured for deducting 1 hit point of the opponent virtual character, and another virtual skill is configured for deducting 3 hit points of the opponent virtual character.

In an aspect, the skill effect of the virtual skill is impact caused on at least one virtual character in the virtual environment after the virtual skill is cast. For example, a virtual skill is configured for deducting a hit point of the opponent virtual character, and another virtual skill is configured for increasing a hit point of the pet virtual character.

In an aspect, the visual effect of the virtual skill is a display pattern in a process casting the virtual skill.

In this solution, a cast effect of the virtual skill is not fixed, but is related to the environmental factor of the battle map where the pet virtual character is located. In other words, the cast effect of the virtual skill is affected by the environmental factor of the battle map, that is, the cast effect of the virtual skill may be different when the same pet virtual character casts a same virtual skill in the battle map having different environmental factors. In an aspect, the cast effect of the virtual skill includes at least one of the skill strength, the skill effect, and the visual effect of the virtual skill. For example, the cast effect of the virtual skill includes the skill strength and the skill effect.

In some aspects, the skill control is displayed in the scene picture of the battle map, and the skill control controls, in response to receiving a trigger operation, the pet virtual character to cast the virtual skill in the battle map. At least one of the skill strength, the skill effect, and the visual effect of the virtual skill is associated with the environmental factor of the battle map.

In an aspect, the battle map corresponds to at least two environmental factors. The at least two environmental factors are two types of environmental factors determined by dividing the battle map from different dimensions. In an aspect, the environmental factor includes a weather condition, a day/night condition, a surface morphology, a temperature condition, and the like.

In an aspect, the environmental factor can enhance the cast effect of the virtual skill. For example, if the virtual skill is a fire skill, and the battle map is a forest environment (where the surface morphology is a forest), skill strength (power), a skill effect (a smoke effect), and a visual effect (a flame size) of the fire skill in the forest environment may be significantly enhanced.

In an aspect, after the turn-based battle ends, the user interface is further switched from the scene picture in which the battle map is displayed to the scene picture in which the world map is displayed. In an aspect, the terminal performs smooth transition between pictures by playing an animation. In an aspect, content of the animation includes at least one of the following: a chagrin picture of a loser and a reward picture of a winner.

After the scene picture of the world map is switched back, battle traces caused by the turn-based battle that just ends are displayed in the partial map in the world map. For example, fierce fighting between two camps in the turn-based battle causes grass in the battle map to be ignited, and after the world map is switched back, grass in the world map is also ignited. If a fire in the battle map has been put out, burned traces may be displayed in the world map.

The battle traces are displayed in the world map, which makes it possible for the world map and the battle map to share the same piece of map data, and helps the battle map to be consistent with the partial map in the world map, thereby reducing image processing pressure when the terminal device performs switching between the battle map and the world map.

In an aspect, the method shown in FIG. 4 further includes: during the turn-based battle, synchronously changing, by the terminal, the environmental factor of the battle map when an environmental factor of the partial map changes due to a reason unrelated to the turn-based battle. In other words, during the battle, the environmental factor of the battle map may change as the environmental factor of the world map changes. In an aspect, the reason unrelated to the turn-based battle is a reason that is not related to the turn-based battle, that is, an event that is of changing the environmental factor and that occurs in the world map.

The change in the environmental factor of the partial map is synchronized to the environmental factor of the battle map, which helps to improve authenticity in the turn-based battle, and reduces the sense of division between the world map and the battle map.

In an aspect, the terminal changes a j^{th} environmental factor of the battle map when an it environmental factor of the partial map changes, where the i^{th} environmental factor is any one of a weather condition, a day/night condition, and a surface morphology; and the j^{th} environmental factor is any one of the weather condition, the day/night condition, and the surface morphology, both i and j being positive integers.

For example, the pet virtual character and the opponent virtual character are being in the turn-based battle, and the master virtual character is holding a bonfire party in the world map. If a fire unfortunately breaks out in the world map during the battle in the battle map, causing grass in the partial map to be ignited, and a burning effect may be synchronized to the battle map, which changes environmental factors of land parcels in the battle map.

For example, the pet virtual character and the opponent virtual character are being in the turn-based battle. During the battle, the world map is changed from originally sunny to rainy, and the weather condition in the battle map is also changed from sunny to rainy.

For example, the pet virtual character and the opponent virtual character are being in the turn-based battle. During the battle, the world map is changed from originally sunny to rainy, and the land parcels in the battle map are originally in a burned state. In this case, flames in the battle map are put out, and the surface morphology is changed from originally “flaming” to grass.

In an aspect, the method shown in FIG. 4 further includes: during the turn-based battle, synchronously changing an environmental factor of the partial map when the environmental factor of the battle map changes due to a reason related to the turn-based battle. In other words, during the battle, the environmental factor of the world map may change with the change in the environmental factor of the battle map.

In an aspect, the reason related to the turn-based battle is a reason that is related to the turn-based battle, that is, an event that is of changing the environmental factor and that occurs in the battle map. For example, the reason related to the turn-based battle includes that the pet virtual character casts the virtual skill, causing a change in the environmental factor in the battle map.

In an aspect, an n^{th} environmental factor of the battle map is changed when an m^{th} environmental factor of the partial map changes, where the m^{th} environmental factor is any one of a weather condition, a day/night condition, and a surface morphology; and the n^{th} environmental factor is any one of the weather condition, the day/night condition, and the surface morphology, both m and n being positive integers.

For example, the pet virtual character and the opponent virtual character are being in the turn-based battle, a fire skill cast by the pet virtual character causes the grass in the battle map to be ignited, and a burning effect may be synchronized to the world map, which changes environmental factors of land parcels in the world map.

For example, the pet virtual character and the opponent virtual character are being in the turn-based battle, an ice skill cast by the pet virtual character causes a river in the battle map to be frozen, and a freezing effect may be synchronized to the world map, so that a land parcel (where the surface morphology is a river) in the world map is also frozen, and the surface morphology is changed into ice.

For example, the pet virtual character and the opponent virtual character are being in the turn-based battle. During the battle, the pet virtual character in the battle map casts a water skill, and the water skill puts out flames in the battle map, so that the surface morphology of the land parcel in the world map is changed from “flaming” to grass.

Based on the above, the same piece of map data is shared by the battle map and the world map that are used in the turn-based battle, so that when the world scene is switched to the battle scene, the battle map can synchronize map data of the world map, thereby achieving consistency of the world map and the battle map, and eliminating the sense of division between the two. By using the method, the server or the terminal only needs to maintain one piece of map data. This helps to save resources consumed by the server or the terminal device in a process of storing and processing the map data.

In addition, in this solution, at least one of the skill strength, the skill effect, and the visual effect of the virtual skill is associated with the environmental factor, so that a cast effect of the virtual skill is enhanced or weakened under the influence of the environmental factor, to cause a player to think about a virtual skill cast method achieving more rewards, thereby enhancing a strategy property of the game. This further helps to increase a dimension pre-battle point selection. Before entering the turn-based battle, the player may select a battlefield that is beneficial to a camp of the player (and/or a battlefield that is not beneficial to an opponent), so that the pet virtual character can case a skill with greater power and a more gorgeous visual effect in the selected battlefield.

In addition, during the turn-based battle, synchronization of environmental factors is maintained between the world map and the battle map. This further eliminates the sense of division between the world scene and the battle scene.

Based on an aspect shown in FIG. 4, “at least one of skill strength, a skill effect, and a visual effect of the virtual skill being associated with an environmental factor of the battle map” in operation 460 may be further subdivided into that the skill strength and/or the skill effect of the virtual skill is associated with an emotion state of the pet virtual character for the battle map. This is equivalent to that in this solution, the pet virtual character has an emotion management system, where the emotion management system is configured to manage the emotion state of the pet virtual character. In an aspect, the environmental factor of the battle map can affect an emotion state of a pet virtual character, and the emotion state of the pet virtual character can affect a cast effect of a virtual skill of the pet virtual character.

For example, if the battle map is a grass environment, and the pet virtual character likes grass, skill power of a skill cast by the pet virtual character in the grass environment is enhanced, and the virtual skill may have an additional constraint effect. In another example, if the weather condition of the battle map is raining, and the pet virtual character disgusts rainy weather, skill power of the virtual skill cast by the pet virtual character is weakened.

In an aspect, the terminal may further display an emotion effect in the user interface based on the emotion state of the pet virtual character for the battle map. In an aspect, the terminal may further display, in the user interface, impact of the emotion state of the pet virtual character on the virtual skill in response to receiving a trigger operation for the emotion effect. For example, a smiling face in FIG. 5 represents liking of a pet virtual character 501 for the battle map. In response that a “smiling face” effect receives a trigger operation, “affinity is [strong], an elf likes a surrounding environment very much, and damage is increased by 50%” is displayed, that is, that an “affinity state” may enhance the skill strength by 50% is displayed.

The environmental factor is associated with the emotion state of the pet virtual character, which helps the player grasp the impact of the environmental factor on the cast effect of the virtual skill, and helps the player adapt to gameplay faster.

In an aspect, the battle map corresponds to at least two environmental factors, where the environmental factor includes a weather condition, a day/night condition, a surface morphology, a temperature condition, and the like.

S1: When a score of environmental factors that the pet virtual character likes among the at least two environmental factors is greater than a score of environmental factors that the pet virtual character disgusts, further display, in the scene picture corresponding to the battle map, an affinity effect for indicating that the pet virtual character is in an affinity state.

In some aspects, the affinity state is configured for indicating that the pet virtual character can adapt to the environmental factor, and the cast effect of the virtual skill is enhanced under the influence of the environmental factor. In an aspect, the terminal determines whether the pet virtual character is in the affinity state based on a difference between the score of environmental factors that the pet virtual character likes and the score of environmental factors that the pet virtual character disgusts in a battle map of a current turn-based battle.

For example, weather of the battle map is sunny, and the surface morphology of the battle map is a floor tile. If the pet virtual character likes sunny weather, and the pet virtual character dislikes or does not disgust the floor tile, it is determined that the score of environmental factors (which is 1) that the pet virtual character likes among the two environmental factors is greater than the score of environmental factors (which is 1) that the pet virtual character disgusts.

In an aspect, the battle map corresponds to a first environmental factor and a second environmental factor. S1 may further include S1-1 and S1-2 below.

S1-1: When the pet virtual character likes both the first environmental factor and the second environmental factor, further display, in the scene picture corresponding to the battle map, a first affinity effect for indicating that the pet virtual character is in a first affinity state.

For example, if the weather of the battle map is sunny, the surface morphology of the battle map is grass, and the pet virtual character likes both sunny weather and grass, the pet virtual character is in the first affinity state, and the first affinity effect is displayed in the user interface. For example, a smiling face shown in FIG. 6 is the first affinity effect, and a pet virtual character 601 shown in FIG. 6 is in the first affinity state.

In an aspect, the first environmental factor is a weather condition or a day/night condition, and the second environmental factor is a surface morphology; or the first environmental factor is a surface morphology, and the second environmental factor is a weather condition or a day/night condition.

In an aspect, when the pet virtual character likes the weather condition, the first environmental factor is the day/night condition, and the second environmental factor is the surface morphology; and when the pet virtual character disgusts the weather condition, the first environmental factor is the weather condition, and the second environmental factor is the surface morphology.

For example, if the environmental factor of the battle map includes sunny weather, daytime, and grass, the pet virtual character likes sunny weather, and it is determined that the pet virtual character likes daytime, it is determined that the pet virtual character likes both the first environmental factor and the second environmental factor.

S1-2: When the pet virtual character likes the first environmental factor and does not disgust the second environmental factor, further display, in the scene picture corresponding to the battle map, a second affinity effect for indicating that the pet virtual character is in a second affinity state.

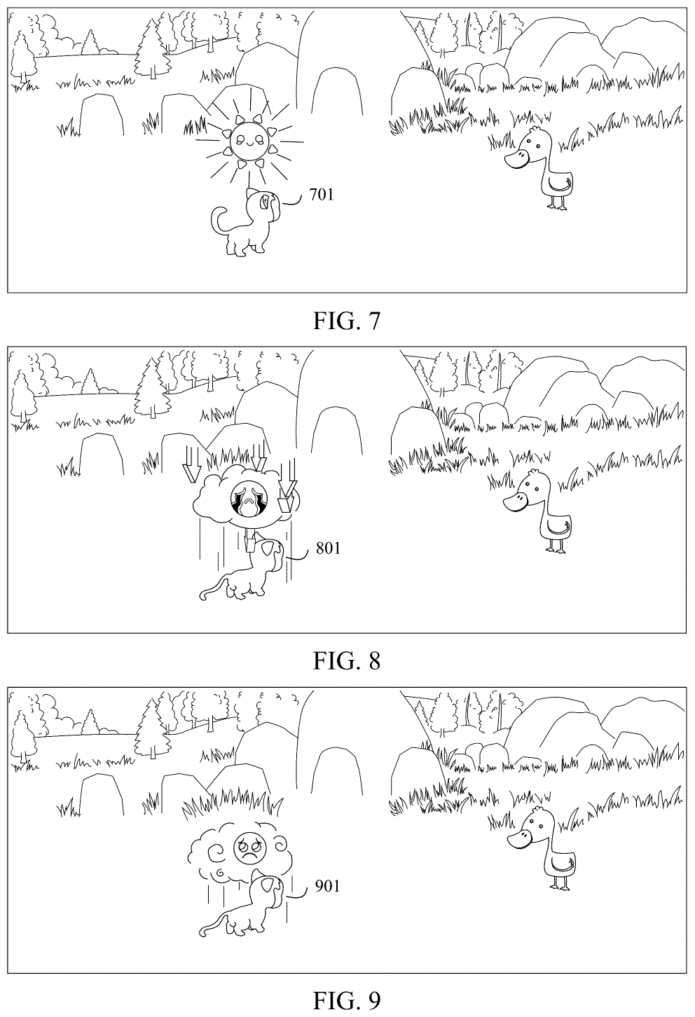

For example, if the weather of the battle map is sunny, the surface morphology of the battle map is the floor tile, and the pet virtual character likes sunny weather but does not disgust the floor tile, the pet virtual character is in the second affinity state, and the second affinity effect is displayed in the user interface. For example, a smiling face shown in FIG. 7 is the second affinity effect, and a pet virtual character 701 shown in FIG. 7 is in the second affinity state. As can be seen from comparison between FIG. 6 and FIG. 7, the smiling face in FIG. 6 is brighter than the smiling face in FIG. 7, that is, an affinity degree of the first affinity state is higher than an affinity degree of the second affinity state.

In an aspect, the first affinity state is superior to the second affinity state. To be specific, a cast effect of a virtual skill of the pet virtual character in the first affinity state is superior to the cast effect of the same virtual skill of the pet virtual character in the second affinity state.

In an aspect, the first environmental factor is a weather condition or a day/night condition, and the second environmental factor is a surface morphology; or the first environmental factor is a surface morphology, and the second environmental factor is a weather condition or a day/night condition.

In an aspect, when the pet virtual character likes the weather condition, the first environmental factor is the day/night condition, and the second environmental factor is the surface morphology; and when the pet virtual character disgusts the weather condition, the first environmental factor is the weather condition, and the second environmental factor is the surface morphology.

For example, if the environmental factor of the battle map includes sunny weather, night, and grass, and the terminal first determines that the pet virtual character likes sunny weather and then determines that the pet virtual character does not disgust night-time, it is determined that the pet virtual character likes the first environmental factor and does not disgust the second environmental factor (or the pet virtual character does not disgust the first environmental factor and likes the second environmental factor).

With the setting of the at least two affinity states and the analysis of the impact of different environmental factors on the cast effect of the virtual skill, methods of using the virtual skill are enriched without causing high computational overheads, thereby improving playability of the game.

S2: When the score of environmental factors that the pet virtual character likes among the at least two environmental factors is less than the score of environmental factors that the pet virtual character disgusts, further display, in the scene picture corresponding to the battle map, a conflict effect for indicating that the pet virtual character is in a conflict state.

For example, weather of the battle map is rainy, and the surface morphology of the battle map is a floor tile. If the pet virtual character disgusts rainy weather and does not disgust the floor tile, it is determined that the score of environmental factors (which is 0) that the pet virtual character likes among the two environmental factors is less than the score of environmental factors (which is 1) that the pet virtual character disgusts.

In an aspect, the battle map corresponds to a first environmental factor and a second environmental factor. S2 may further include S2-1 and S2-2 below.

S2-1: When the pet virtual character disgusts both the first environmental factor and the second environmental factor, further display, in the scene picture corresponding to the battle map, a first conflict effect for indicating that the pet virtual character is in a first conflict state.

In an aspect, the skill strength and the skill effect of the virtual skill change when the pet virtual character is in the first conflict state. For example, the skill strength of the virtual skill is inferior to original skill strength of the virtual skill, where the original skill strength is skill strength of the virtual skill when the virtual skill is not affected by the environmental factor.

For example, if the weather of the battle map is rainy, the surface morphology of the battle map is sand, and the pet virtual character disgusts both rainy weather and sand, the pet virtual character is in the first conflict state, and the first conflict effect is displayed in the user interface. For example, a crying face shown in FIG. 8 is the first conflict effect, and a pet virtual character 801 shown in FIG. 8 is in the first conflict state

In an aspect, the first environmental factor is a weather condition or a day/night condition, and the second environmental factor is a surface morphology; or the first environmental factor is a surface morphology, and the second environmental factor is a weather condition or a day/night condition.

In an aspect, when the pet virtual character likes the weather condition, the first environmental factor is the day/night condition, and the second environmental factor is the surface morphology; and when the pet virtual character disgusts the weather condition, the first environmental factor is the weather condition, and the second environmental factor is the surface morphology.

For example, if the environmental factor of the battle map includes rainy weather, daytime, and sand, the pet virtual character disgusts rainy weather, and it is determined that the pet virtual character disgusts sand, it is determined that the pet virtual character disgusts both the first environmental factor and the second environmental factor.

S2-2: When the pet virtual character disgusts the first environmental factor and dislikes the second environmental factor, further display, in the scene picture corresponding to the battle map, a second conflict effect for indicating that the pet virtual character is in a second conflict state.

In an aspect, a capability of the second conflict state for weakening the cast effect of the virtual skill is inferior to a capability of the first conflict state for weakening the cast effect of the virtual skill. For example, original skill strength of a virtual skill is 10, and when the pet virtual character is in the first conflict state, the skill strength of the virtual skill is 5; and when the pet virtual character is in the second conflict state, the skill strength of the virtual skill is 7.5. For example, if the weather of the battle map is rainy, the surface morphology of the battle map is a floor tile, and the pet virtual character disgusts rainy weather and dislikes the floor tile, the pet virtual character is in the second conflict state, and the second conflict effect is displayed in the user interface. For example, a crying face shown in FIG. 9 is the second conflict effect, and a pet virtual character 901 shown in FIG. 9 is in the second conflict state. As can be seen from comparison between FIG. 8 and FIG. 9, the crying face in FIG. 8 is glummer than the crying face in FIG. 9, that is, a conflict degree of the first conflict state is higher than a conflict degree of the second conflict state.

In an aspect, the first environmental factor is a weather condition or a day/night condition, and the second environmental factor is a surface morphology; or the first environmental factor is a surface morphology, and the second environmental factor is a weather condition or a day/night condition.

In an aspect, when the pet virtual character likes the weather condition, the first environmental factor is the day/night condition, and the second environmental factor is the surface morphology; and when the pet virtual character disgusts the weather condition, the first environmental factor is the weather condition, and the second environmental factor is the surface morphology.

For example, if the environmental factor of the battle map includes daytime, night-time, and sand, the pet virtual character likes daytime, and it is determined that the pet virtual character dislikes night-time and disgusts sand, in this case, it is determined that the pet virtual character disgusts the first environmental factor and dislikes the second environmental factor (or the pet virtual character dislikes the first environmental factor and disgusts the second environmental factor).

Based on the above, the skill strength and/or the skill effect of the virtual skill is associated with the emotion state of the pet virtual character for the battle map, and the emotion state of the pet virtual character for the battle map is considered, so that when the pet virtual character is in affinity with the battle map, the virtual skill cast by the pet virtual character has greater power.

In addition, by using the foregoing method, the world map and the battle map are divided into a plurality of land parcels. Land parcels of the partial map (which is in the world map) are in a one-to-one correspondence with land parcels in the battle map, environmental factors of the land parcels are also in a one-to-one correspondence, and the land parcels with different environmental factors may have different effects on skills. Therefore, the foregoing method further enriches association between the world map and the battle map, and association between the world map and the turn-based battle. That the power of the skill is affected from a dimension of the environmental factor of the land parcel may be subdivided into affecting the power of the skill according to a land parcel where the pet virtual character is located and a land parcel where the opponent virtual character is located, which further improves the strategy property of the game.

Based on an aspect shown in FIG. 4, that at least one of skill strength, a skill effect, and a visual effect of the virtual skill being associated with an environmental factor of the battle map in operation 460 may be further subdivided as follows: The visual effect of the virtual skill is obtained by fusing the environmental factor of the battle map and an attribute of a basic virtual skill of the pet virtual character. In other words, the terminal superimposes the environmental factor of the battle map and the attribute of the basic virtual skill of the pet virtual character, to determine the visual effect of the virtual skill.

In some aspects, the basic virtual skill is a virtual skill not affected by the environmental factor. The attribute of the basic virtual skill is configured for representing a cast effect of an initial virtual skill.

For example, if the battle map is a fire environment (where the surface morphology is a flame), and the basic virtual skill of the pet virtual character is a wind skill, in this case, the pet virtual character casts, in the fire environment, a virtual skill “fire tornado” that fusing a wind attribute and a fire attribute. For example, if the battle map is a water environment (where the surface morphology is a river), and the basic virtual skill of the pet virtual character is a light skill, in this case, the pet virtual character casts, in the water environment, a virtual skill fusing a light attribute and a water attribute, and the virtual skill obtained after fusion has a “sparkling” visual effect.

In an aspect, the battle map includes at least two land parcels. The visual effect of the virtual skill is obtained by fusing an environmental factor of the land parcel where the pet virtual character is located and the attribute of the basic virtual skill of the pet virtual character; and/or the visual effect of the virtual skill is obtained by fusing an environmental factor of the land parcel where the opponent virtual character is located and the attribute of the basic virtual skill of the pet virtual character, the opponent virtual character being a target virtual character of the virtual skill.

For example, the land parcel where the pet virtual character is located is a fire land parcel (where the surface morphology is a flame), and the basic virtual skill of the pet virtual character is a wind skill, in this case, the skill cast by the pet virtual character is represented as a “fire tornado”.

In another example, if the land parcel where the pet virtual character is located is raining (where the weather condition is rainy), and the basic virtual skill of the pet virtual character is a water skill, in this case, the skill cast by the pet virtual character is represented as a “waterspout”.

In an aspect, the visual effect of the virtual skill is obtained by fusing the environmental factor of the land parcel where the opponent virtual character is located and the attribute of the basic virtual skill of the pet virtual character.

For example, the land parcel where the opponent virtual character is located is a water land parcel (where the surface morphology is a river), and the basic virtual skill of the pet virtual character is a light skill, in this case, the skill cast by the pet virtual character represents a “sparkling” visual effect.

In another example, if the land parcel where the opponent virtual character is located is windy (where the weather condition is windy), and the basic virtual skill of the pet virtual character is a fire skill, in this case, the skill cast by the pet virtual character is represented as a “fire tornado”.

In an aspect, whether the visual effect of the virtual skill is related to the environmental factor of the land parcel where the opponent virtual character is located or is related to the environmental factor of the land parcel where the pet virtual character is located is determined according to a cast destination of the virtual skill. For example, if the cast destination of the virtual skill is the land parcel where the pet virtual character is located, the terminal determines that the visual effect of the virtual skill is related to the environmental factor of the land parcel where the pet virtual character is located; and if the cast destination of the virtual skill is the land parcel where the opponent virtual character is located, the terminal determines that the visual effect of the virtual skill is related to the environmental factor of the land parcel where the opponent virtual character is located.

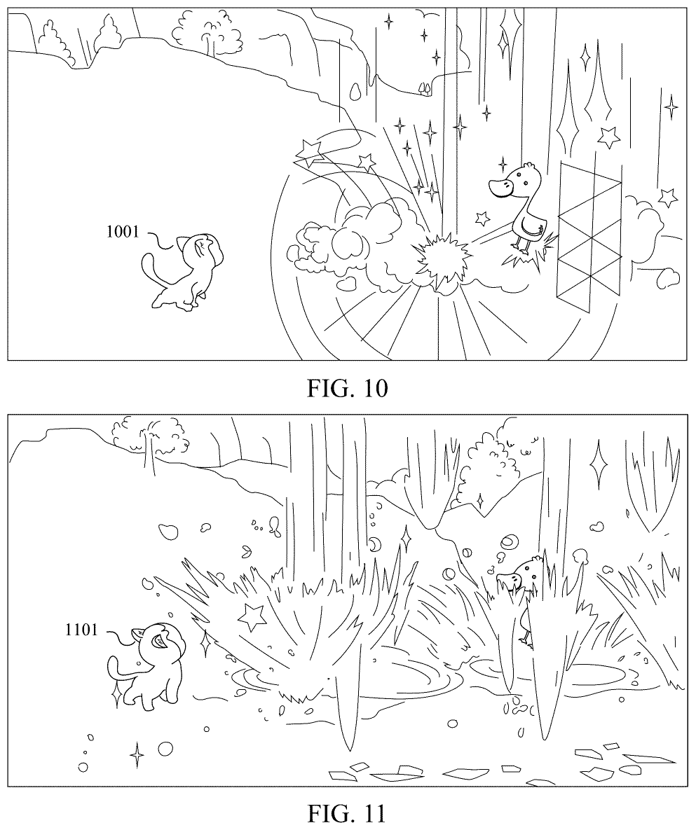

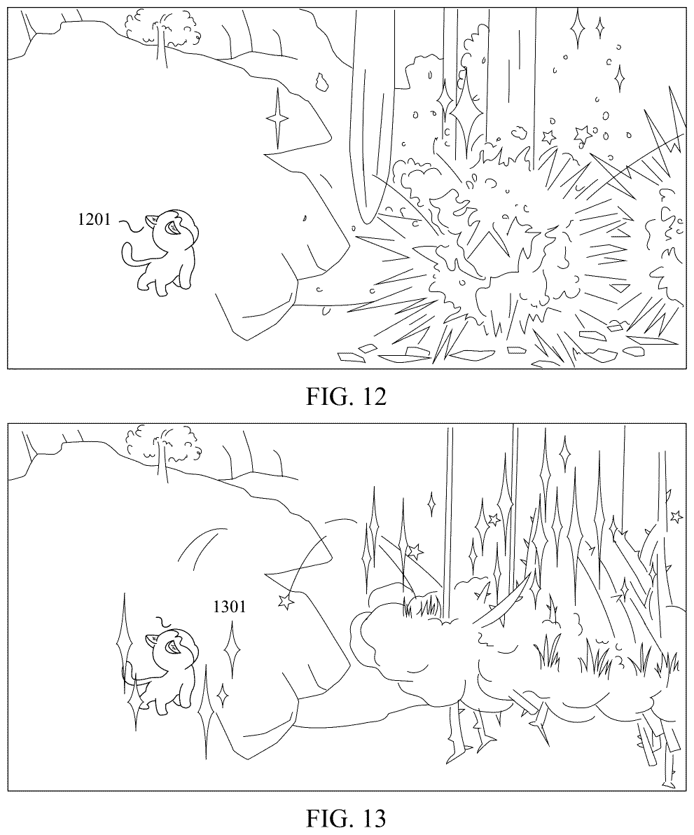

For example, FIG. 10 shows a basic virtual skill (a light skill) of a pet virtual character 1001. FIG. 11 shows a basic virtual skill (a light skill) of a pet virtual character 1101. The land parcel where the opponent virtual character is located is a water land parcel, and a “sparkling” visual effect is displayed in the user interface. FIG. 12 shows a basic virtual skill (a light skill) of a pet virtual character 1201. The land parcel where the opponent virtual character is located is a fire land parcel, and a “flaming” visual effect is displayed in the user interface. FIG. 13 shows a basic virtual skill (a light skill) of a pet virtual character 1301. The land parcel where the opponent virtual character is located is a grass land parcel (where the surface morphology is grass), and a “grass-growing” visual effect is displayed in the user interface.

In an aspect, the skill strength of the virtual skill obtained after fusion is higher than skill strength of the basic virtual skill; and/or the skill effect of the virtual skill obtained after fusion is superior to a skill effect of the basic virtual skill.

For example, skill strength of the “fire tornado” is higher than skill strength of the wind skill of the pet virtual character. Compared with the wind skill of the pet virtual character, the “fire tornado” further has an additional burning effect.

In another example, skill strength of the “sparkling” virtual skill is higher than skill strength of the light skill of the pet virtual character. Compared with the light skill of the pet virtual character, the “sparkling” virtual skill further has an additional slowing effect.

Based on the above, the visual effect of the virtual skill is obtained by fusing the environmental factor of the battle map and the attribute of the basic virtual skill of the pet virtual character, and the attribute of the virtual skill and the environmental factor of the battle map are considered, so that when the attribute and the environmental factor support fusion, a virtual skill with a more gorgeous visual effect is obtained, and power of the skill is enhanced.

In addition, considering that the battle map includes a plurality of land parcels, the environmental factor of the land parcel where the pet virtual character is located may be different from the environmental factor of the land parcel where the opponent virtual character is located. The visual effect of the virtual skill may be obtained by fusing the environmental factor of the land parcel where the pet virtual character is located and the attribute of the basic virtual skill, or may be obtained by fusing the environmental factor of the land parcel where the opponent virtual character is located and the attribute of the basic virtual skill. In this way, when casting the virtual skill, the player may further consider a land parcel where a camp of the player is located and a land parcel where an opponent camp is located, which further enhances the strategy property of the game.

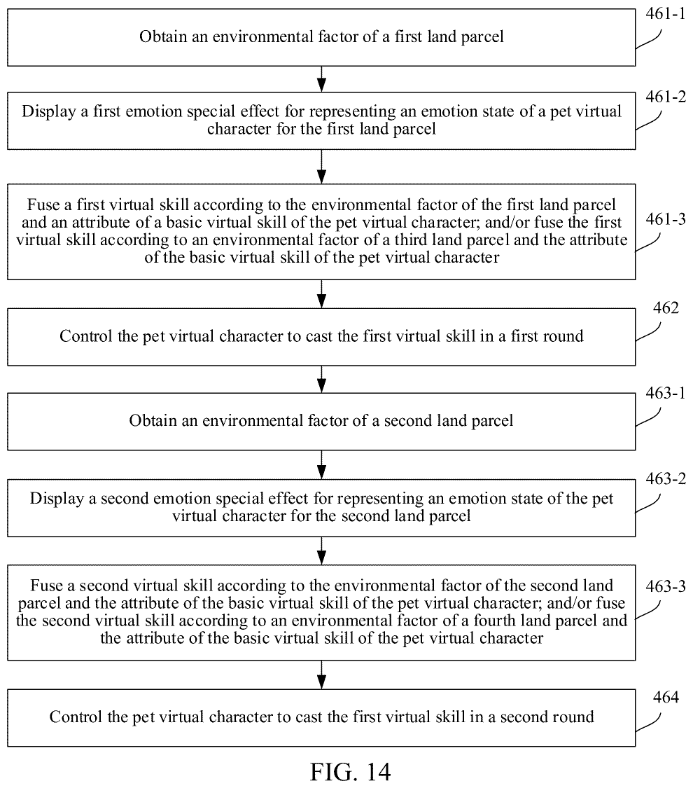

Based on the aspect shown in FIG. 4, the battle map includes at least two land parcels. A manner in which the pet virtual character casts the virtual skill is described in detail below by using two different rounds in the turn-based battle. FIG. 14 is a flowchart of a turn-based battle process according to an exemplary aspect of this disclosure. Operation 460 in FIG. 4 may be replaced with operation 462 in FIG. 14, operations 461-1, 461-2, and 461-3 are further included before operation 462, and operations 463-1, 463-2, 463-3, and 464 are further included after operation 462.

Operation 461-1: Obtain environmental factors of a first land parcel and a third land parcel. The first land parcel is a land parcel where the pet virtual character is located in a first round, and the third land parcel is a land parcel where the opponent virtual character is located in the first round.

In the turn-based battle process provided in this disclosure, the pet virtual character may be located in different land parcels (at different spatial positions herein) in different rounds, and the opponent virtual character may also be located in different land parcels in different rounds.

The pet virtual character is used as an example for description, and the reason includes at least one of the following:
The pet virtual character is affected by the opponent virtual character and is forced to move to different land parcels. For example, in a round of the opponent virtual character, the opponent virtual character casts a skill on the pet virtual character, forced displacement effects such as knowing away and knocking back caused by the skill act on the pet virtual character, and the pet virtual character moves from a current land parcel to another land parcel.
The pet virtual character is affected by game settings and actively moves to different land parcels. For example, as set in the game, each time the pet virtual character casts a virtual skill, the pet virtual character moves from a current land parcel to another land parcel.
The pet virtual character searches for a suitable land parcel before casting the skill each time. For example, in the first round, before casting the virtual skill, the pet virtual character detects whether the current land parcel is suitable for casting a skill, and if the current land parcel is not suitable, the pet virtual character actively moves to an appropriate land parcel. For example, in a previous round, the pet virtual character is forced by the opponent virtual character to move to a land parcel with a surface morphology of a flame, and before casting the skill in the first round, the pet virtual character actively moves to a closest land parcel with a surface morphology of grass.

In an aspect, the environmental factor of the first land parcel includes but is not limited to a weather condition, a day/night condition, a temperature condition, and a surface morphology of the first land parcel. The environmental factor of the third land parcel includes but is not limited to a weather condition, a day/night condition, a temperature condition, and a surface morphology of the third land parcel. In an aspect, the environmental factor of the first land parcel and the environmental factor of the third land parcel are of the same type. For example, the environmental factor of the third land parcel includes the weather condition and the surface morphology, and in this case, the environmental factor of the first land parcel also includes the weather condition and the surface morphology.

Operation 461-2: Display a first emotion effect for representing an emotion state of the pet virtual character for the first land parcel.

The terminal displays, in the user interface, the first emotion effect of the emotion state of the pet virtual character for the first land parcel according to the obtained environmental factor of the first land parcel. For detailed content of an emotion effect, refer to related descriptions of FIG. 5 to FIG. 9. Details are not described herein again.

In an aspect, the emotion effect is configured for affecting the skill strength and/or the skill effect of the virtual skill. If the emotion effect is affinity, the skill strength of the virtual skill is enhanced, and the skill effect is optimized. If the emotion effect is conflict, the skill strength of the virtual skill is reduced, and the skill effect is weakened.

Each time before the pet virtual character casts a virtual skill, an environmental factor of the land parcel where the pet virtual character is located is obtained again, and an emotion effect is displayed based on the environmental factor. Therefore, in the turn-based battle process, a skill cast by the pet virtual character in each round is closely related to the land parcel where the pet virtual character is located.

Operation 461-3: Fuse the first virtual skill according to the environmental factor of the first land parcel and an attribute of a basic virtual skill of the pet virtual character; and/or fuse the first virtual skill according to the environmental factor of the third land parcel and an attribute of a basic virtual skill of the pet virtual character.

The first virtual skill is a virtual skill cast by the pet virtual character in the first round.

For example, the terminal fuses the first virtual skill according to the obtained environmental factor of the third land parcel and the attribute of the basic virtual skill of the pet virtual character. For example, the surface morphology of the third land parcel is grass, and the pet virtual character has a basic virtual skill with a fire attribute. In this case, the first virtual skill obtained after fusion is represented as “burning fire”. For detailed content of skill fusion, refer to related descriptions of FIG. 10 to FIG. 13. Details are not described herein again.

In an aspect, the virtual skill obtained after fusion has a visual effect different from that of the basic virtual skill. The skill strength of the virtual skill obtained after fusion is higher than skill strength of the basic virtual skill; and/or the skill effect of the virtual skill obtained after fusion is superior to a skill effect of the basic virtual skill.

Each time before the pet virtual character casts a virtual skill, an environmental factor of the land parcel where the pet virtual character is located is obtained again, and whether skill fusion is required is determined. If it is determined, according to a pre-configuration, that skill fusion is to be performed, a visual effect after fusion is displayed in the user interface. Therefore, in the turn-based battle process, a skill cast by the pet virtual character in each round is closely related to the land parcel where the pet virtual character is located.

Operation 462: Control the pet virtual character to cast the first virtual skill in the first round.

With reference to the emotion state of the pet virtual character and skill fusion, at least one of the skill strength, the skill effect, and the visual effect of the first virtual skill is affected. The pet virtual character is controlled to cast the first virtual skill in the first round.

Operation 463-1: Obtain environmental factors of a second land parcel and a fourth land parcel.

The second land parcel is a land parcel where the pet virtual character is located in a second round, and the fourth land parcel is a land parcel where the opponent virtual character is located in the second round. In this disclosure, the first round and the second round are different rounds, and the first land parcel and the second land parcel are different land parcels. The different land parcels mean that geographic positions of the first land parcel and the second land parcel are different, or environmental factors of the first land parcel and the second land parcel are different.

In an aspect, the environmental factor of the second land parcel includes but is not limited to a weather condition, a day/night condition, a temperature condition, and a surface morphology of the second land parcel. The environmental factor of the fourth land parcel includes but is not limited to a weather condition, a day/night condition, a temperature condition, and a surface morphology of the fourth land parcel.

In the turn-based battle process provided in this disclosure, the pet virtual character may be located in different land parcels (with different environmental factors herein) in different rounds, and the opponent virtual character may also be located in different land parcels in different rounds.

The pet virtual character is used as an example, and the reason includes at least one of the following:
In the battle map, environmental factors of the land parcels are changed due to the influence of a virtual character in a player's own camp and/or a virtual character of an opponent camp.

For example, if the opponent virtual character casts an ice skill on a subordinate virtual character, and the ice skill is performed to freeze a water land parcel (where the surface morphology is a river) where the subordinate virtual character is located, in this case, the water land parcel is changed into an ice land parcel (where the surface morphology is ice), and the surface morphology of the land parcel is maintained in the subsequent turn-based battle. In other words, the environmental factor of the battle map is associated with a battle status in a combat process of the turn-based battle.
Environmental factors of land parcels in the world map are changed, and in this case, environmental factors of corresponding land parcels in the battle map are correspondingly changed.

For example, a weather condition in the world map is changed from originally sunny to rainy, and a weather condition in the battle map is also changed from sunny to rainy. In other words, the environmental factor of the battle map is associated with the environmental factor of the world map.

The environmental factor is associated with the battle status in the turn-based battle process. In this way, during the turn-based battle, the environmental factor is changed with the virtual skill cast by the pet virtual character, which helps to improve richness in the gameplay of the turn-based battle. In addition, the environmental factor is adjusted based on the battle status of the turn-based battle, and there is no need for the server to actively adjust the environmental factor, which helps to reduce processing pressure on the server.

Operation 463-2: Display a second emotion effect for representing an emotion state of the pet virtual character for the second land parcel.

The terminal displays, according to the obtained environmental factor of the second land parcel, the second emotion effect of the emotion state of the pet virtual character for the second land parcel in the user interface. For detailed content of an emotion effect, refer to related descriptions of FIG. 5 to FIG. 9. Details are not described herein again.

In an aspect, the emotion effect is configured for affecting the skill strength and/or the skill effect of the virtual skill. If the emotion effect is affinity, the skill strength of the virtual skill is enhanced, and the skill effect is optimized. If the emotion effect is conflict, the skill strength of the virtual skill is reduced, and the skill effect is weakened.

The emotion state of the pet virtual character is visualized by displaying an emotion effect corresponding to the emotion state, so that expression of the emotion state is more intuitive.

Each time before the pet virtual character casts a virtual skill, an environmental factor of the land parcel where the pet virtual character is located is obtained again, and an emotion effect is displayed based on the environmental factor. Therefore, in the turn-based battle process, a skill cast by the pet virtual character in each round is closely related to the land parcel where the pet virtual character is located.

Operation 463-3: Fuse the second virtual skill according to the environmental factor of the second land parcel and the attribute of the basic virtual skill of the pet virtual character; and/or fuse the second virtual skill according to the environmental factor of the fourth land parcel and the attribute of the basic virtual skill of the pet virtual character.

The second virtual skill is a virtual skill cast by the pet virtual character in the second round.

For example, the terminal fuses the second virtual skill according to the obtained environmental factor of the fourth land parcel and the attribute of the basic virtual skill of the pet virtual character. For detailed content of skill fusion, refer to related descriptions of FIG. 10 to FIG. 13. Details are not described herein again.

In an aspect, the virtual skill obtained after fusion has a visual effect different from that of the basic virtual skill. The skill strength of the virtual skill obtained after fusion is higher than skill strength of the basic virtual skill; and/or the skill effect of the virtual skill obtained after fusion is superior to a skill effect of the basic virtual skill.

Each time before the pet virtual character casts a virtual skill, an environmental factor of the land parcel where the pet virtual character is located is obtained again, and whether skill fusion is required is determined. If it is determined, according to a pre-configuration, to perform skill fusion, a visual effect after fusion is displayed in the user interface. Therefore, in the turn-based battle process, a skill cast by the pet virtual character in each round is closely related to the land parcel where the pet virtual character is located.

Operation 464: Control the pet virtual character to cast the second virtual skill in the second round.

With reference to the emotion state of the pet virtual character and skill fusion, at least one of the skill strength, the skill effect, and the visual effect of the second virtual skill is affected. The pet virtual character is controlled to cast the second virtual skill in the second round.

Based on the above, the land parcels of the world map are in a one-to-one correspondence with the land parcels of the battle map, environmental factors of the land parcels in the battle map may change as environmental factors of the land parcels in the world map change, and the environmental factors of the land parcels in the battle map may change with the battle status of the turn-based battle. In this case, impact of changed land parcels on the skill (the skill strength/the skill effect/the visual effect) of the pet virtual character may also change, so that the strategy property of the game is further improved.

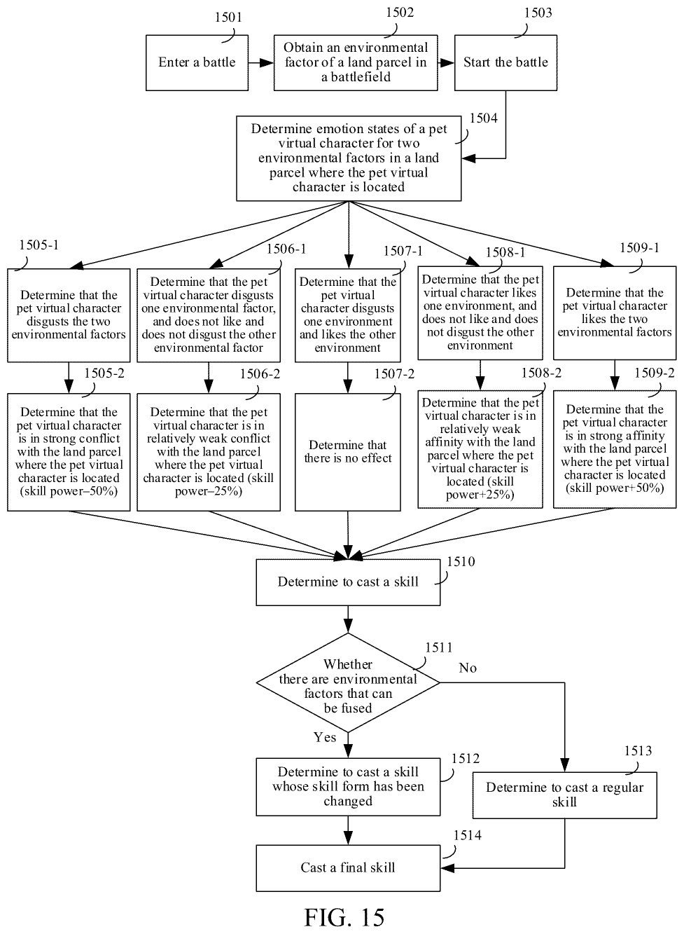

FIG. 15 is a flowchart of a turn-based battle interface display method according to an exemplary aspect of this disclosure. A description is made below by using an example in which the method is performed by a terminal (or an application supporting a virtual environment) shown in FIG. 3. The method includes:

Operation 1501: Enter a battle.

After the battle is initiated, the terminal may select a battlefield at an appropriate position closest to an initiation position. In an aspect, the battlefield is a circular region with a radius of 10. In an aspect, the battlefield includes a plurality of land parcels, where the land parcel is a 0.5*0.5 rectangular block. After the battlefield is selected, the terminal may detect a surface morphology, a weather condition, a day/night condition, and the like of the battlefield, and record the conditions as battlefield information.

Operation 1502: Obtain an environmental factor of a land parcel in a battlefield.

The environmental factor includes two parts. The first part is a land parcel material. Land parcel materials of corresponding land parcels in a coordinate range of virtual characters in two camps are obtained, and corresponding environment enumeration is matched in a planning configuration table based on the material. For example, the planning configuration table is configured with a flame material, a river material, an ice material, a grass material, a floor tile material, and the like, and as can be seen from matching, the pet virtual character is in the grass material, and the opponent virtual character is in the river material.

The second part is a TOD environment. A combination of a weather condition and a day/night condition of the corresponding land parcels in the coordinate range of the virtual characters in the two camps are obtained, and corresponding environment enumeration is matched in the planning configuration table. For example, the planning configuration table includes configurations such as sunny daytime, sunny night-time, rainy daytime, rainy night-time, windy daytime, windy night-time, and the like, and as can be seen from matching, the virtual characters in the two camps are at sunny daytime.

Operation 1503: Start the battle.

It is determined that the pet virtual character and the opponent virtual character start the battle.

Operation 1504: Determine emotion states of the pet virtual character for two environmental factors.

Two environmental factors (the land parcel material+the combination of the weather condition and the day/night condition) have been obtained in operation 1502, and an operation of determining the emotion states of the pet virtual character for the two environmental factors is performed.

Operation 1505-1: Determine that the pet virtual character disgusts the two environmental factors.

Operation 1505-2 is performed when the pet virtual character disgusts the two environmental factors in a land parcel where the pet virtual character is located.

Operation 1505-2: Determine that the pet virtual character is in strong conflict with the land parcel where the pet virtual character is located (skill power-50%).

It is determined that the pet virtual character is in strong conflict with the land parcel where the pet virtual character is located, and the skill power of a skill of the pet virtual character is weakened by 50%.

Operation 1506-1: Determine that the pet virtual character disgusts one environmental factor, and dislikes and does not disgust the other environmental factor.

Operation 1506-2 is performed when the pet virtual character disgusts one environmental factor of the land parcel where the pet virtual character is located, and does not like and does not disgust the other environmental factor.

Operation 1506-2: Determine that the pet virtual character is in relatively weak conflict with the land parcel where the pet virtual character is located (skill power-25%).

It is determined that the pet virtual character is in relatively weak conflict with the land parcel where the pet virtual character is located, and the skill power of the skill of the pet virtual character is weakened by 25%.

Operation 1507-1: Determine that the pet virtual character disgusts one environment and likes the other environment.

Operation 1507-2 is performed when the pet virtual character disgusts one environment of the land parcel where the pet virtual character is located, and likes the other environment.

Operation 1507-2: Determine that there is no effect.

It is determined that the pet virtual character is indifferent to the land parcel where the pet virtual character is located, and the skill power of the skill of the pet virtual character is not changed.

Operation 1508-1: Determine that the pet virtual character likes one environment, and dislikes and does not disgust the other environment.

Operation 1508-2 is performed when the pet virtual character likes one environment, and dislikes and does not disgust the other environment.

Operation 1508-2: Determine that the pet virtual character is in relatively weak affinity with the land parcel where the pet virtual character is located (skill power+25%).

It is determined that the pet virtual character is in relatively weak affinity with the land parcel where the pet virtual character is located, and the skill power of the skill of the virtual character is enhanced by 25%.

Operation 1509-1: Determine that the pet virtual character likes the two environmental factors.

Operation 1509-2 is performed when the pet virtual character likes the two environmental factors.

Operation 1509-2: Determine that the pet virtual character is in strong affinity with the land parcel where the pet virtual character is located (skill power+50%).

It is determined that the pet virtual character is in relatively strong affinity with the land parcel where the pet virtual character is located, and the skill power of the skill of the virtual character is enhanced by 50%.

Operation 1510: Determine to cast a skill.

It is determined that the pet virtual character is to cast a virtual skill.

Operation 1511: Whether there are environmental factors that can be fused.

The terminal determines whether environmental factors that can be fused exist in the land parcel where the pet virtual character is located and a land parcel where the opponent virtual character is located. If exists, operation 1512 is performed, or if not exist, operation 1513 is performed.

Operation 1512: Determine to cast a skill whose skill form has been changed.

The terminal performs skill fusion according to the determined environmental factors that can be fused and with reference to regular skills of the pet virtual character, and determines to cast the skill whose skill form has been changed.

Operation 1513: Determine to cast a regular skill.

The terminal determines that the environmental factors that can be fused do not exist, and determines that the pet virtual character casts the regular skill.

Operation 1514: Cast a final skill.

The pet virtual character is controlled to cast the final skill.

Based on the above, the same piece of map data is shared by the battle map and the world map that are used in the turn-based battle, so that when the world scene is switched to the battle scene, the sense of division between the two is eliminated.

In addition, at least one of the skill strength, the skill effect, and the visual effect of the virtual skill is associated with the environmental factor, which enhances the strategy property of the game. This helps to increase a dimension pre-battle point selection. Before entering the turn-based battle, the player may select a battlefield that is beneficial to a camp of the player (and/or a battlefield that is not beneficial to an opponent), so that the pet virtual character can case a skill with greater power and a more gorgeous visual effect in the selected battlefield.

Related content on a technical side of the turn-based battle interface display method is described below.

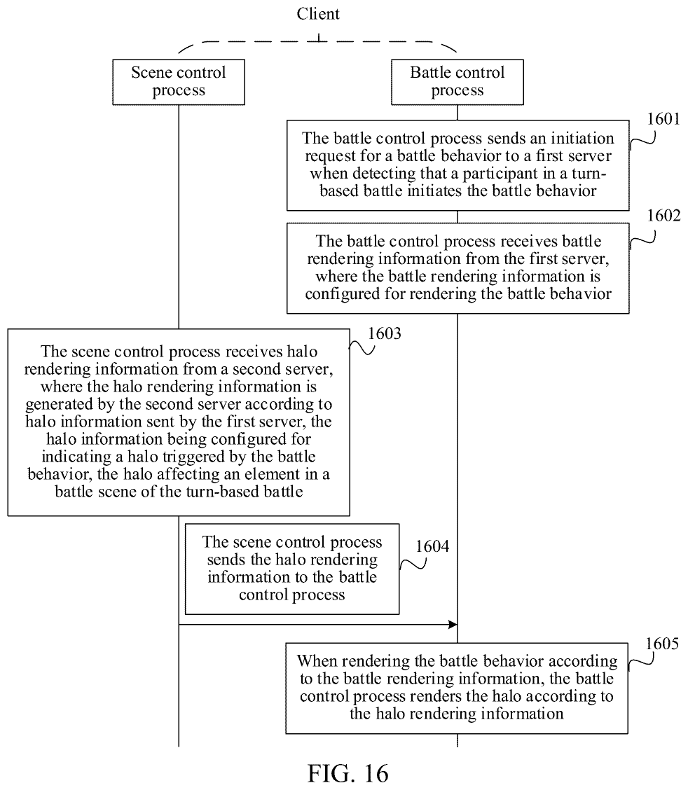

FIG. 16 is a flowchart of a turn-based battle interface display method according to an exemplary aspect of this disclosure. An execution entity of the method aspect shown in FIG. 16 may be a terminal (or an application supporting a virtual environment) shown in FIG. 3. The method may include the following operations (operations 1601 to 1605).

Operation 1601: A battle control process sends an initiation request for a battle behavior to a first server when detecting that a participant in a turn-based battle initiates the battle behavior.

In this aspect of this disclosure, the battle control process is a process used to process content associated with the battle scene. For example, the battle control process can realize rendering for the above-mentioned battle process, such as rendering the behaviors of the pet virtual characters and an opponent unit during the battle.

The participant in the turn-based battle may be the pet virtual character, or may be the opponent unit of the pet virtual character. The battle behavior may be combat behaviors to be performed by the participant in response to a battle control operation by the player, for example, behaviors such as skill casting, normal attack, escaping, using virtual props, defense, and the like. The battle behavior may alternatively be a combat behavior to be performed by an artificial intelligence-controlled participant. This is not limited in this aspect of this disclosure.

The first server is a back-end server of the application, and corresponds to the battle control process. The first server may execute battle processing logic to process a control signal generated by the player in the battle scene, to advance the battle process. The first server may be further configured to process the initiation request for the battle behavior. For example, the first server may perform logical processing on the battle behavior by executing battle behavior processing logic, and generate battle rendering information, to render and display the battle behavior. The first server is the same as that in the foregoing aspect. Details are not described herein again.

The initiation request for the battle behavior is configured for requesting to initiate rendering on the battle behavior and obtain information required for the rendering on the battle behavior, that is, the battle rendering information. The initiation request may include identification information of the battle behavior, for example, identification information of skills, identification information of virtual props, and the like.

In an aspect, when the master virtual character encounters the opponent unit, the player may choose to start the turn-based battle. In an example, when the turn-based battle starts, a battle picture display process of the turn-based battle may be as follows:
1. When entering the turn-based battle is entered, a scene control process obtains basic information corresponding to the participant in the turn-based battle and environmental information corresponding to the battle scene, and sends the basic information and the environmental information to a second server.

In this aspect of this disclosure, the scene control process is a process used to process content associated with the world scene. For example, the scene control process may render activities of the master virtual character in the world scene. The scene control process and the battle control process are two different processes that are independent of each other.

The basic information may be character information required in the battle, for example, a hit point, a level, an attribute, and a skill of the participant, an attribute and a skill of the opponent unit, and the like. For example, the basic information may include information such as a level and a health point of the master virtual character, an attribute and a skill of the pet virtual character used by the master virtual character, an attribute and a skill of the opponent unit, and the like.

The environmental information corresponding to the battle scene may be environmental information corresponding to the battle map, for example, land parcel information, time information, weather information, and the like. In an aspect, in the first round of battle, an environmental affinity between the pet virtual character and the battle scene may be determined according to the environmental information, to determine a final buff or debuff effect of the skill of the pet virtual character in the first round of battle.

The second server is a back-end server of a target application, and corresponds to the scene control process. The second server may execute scene processing logic to process a control signal generated by the player in the world scene, to advance and render the activities of the master virtual character in the world scene. The second server is the same as that in the foregoing aspect. Details are not described herein again.

After receiving the basic information and the environmental information, the second server sends the basic information and the environmental information to the first server.
2. The battle control process receives a battle picture of the turn-based battle from the first server. The battle picture of the turn-based battle is generated by the first server according to the basic information and environmental information sent by the second server.

The battle picture may be a picture in which the pet virtual character and the opponent unit battle in the battle scene. The first server may execute battle behavior processing logic and generate a battle picture (or battle picture rendering information) based on the basic information and the environmental information from the second server, and deliver the battle picture to the battle control process.
3. The battle control process displays the battle picture of the turn-based battle.

In an aspect, the battle control process can directly display the battle picture in the user interface, or render the battle picture according to the battle picture rendering information. This is not limited in this aspect of this disclosure.

Operation 1602: The battle control process receives battle rendering information from the first server, where the battle rendering information is configured for rendering the battle behavior.

The battle rendering information may be a series of behavior control parameters related to the battle behavior in a time dimension. The pet virtual character may be controlled, according to the behavior control parameters, to complete a set of actions or performances. For example, when the battle behavior is to cast a skill, the battle control process controls, according to the battle rendering information, the pet virtual character to complete a set of skill cast actions, thereby completing rendering on skill casting.

Operation 1603: The scene control process receives halo rendering information from the second server, where the halo rendering information is generated by the second server according to halo information sent by the first server, the halo information being configured for indicating a halo triggered by the battle behavior, the halo affecting an element in a battle scene of the turn-based battle.

The halo rendering information may be a series of element control parameters related to the halo in the time dimension, some elements (such as fire elements) may be controlled, according to the element control parameters, to affect an environment (such as land parcels). For example, when the halo is a flame halo, a conversion process in which the fire element converts the land parcel from a grass attribute to a fire attribute may be rendered according to the corresponding halo rendering information.

In an aspect, halo processing logic is run on the second server, and a halo indicated by the halo information (for example, identification information of the halo) is logically processed, so that halo rendering information corresponding to the halo may be obtained. After generating the halo rendering information, the second server sends the halo rendering information to the scene control process.

In an example, when determining that the halo is triggered by the battle behavior, the first server sends the halo information to the second server. When it is determined that the battle behavior cannot trigger the halo, only the battle behavior is logically processed, and information such as damage caused, Buff added, movement caused, and the like are determined, to generate the battle rendering information.

In an aspect, the first server also correspondingly maintains a relationship table between the battle behavior and the halo. The relationship table may be queried to determine whether the battle behavior can trigger the halo. When a halo is triggered, halo information of the halo may further be determined according to the relationship table.

Operation 1604: The scene control process sends the halo rendering information to the battle control process.

After receiving the halo rendering information, the scene control process may first cache the halo rendering information, and then send the halo rendering information to the battle control process after caching the halo rendering information. In this way, the battle control process first obtains the battle rendering information, and then obtains the halo rendering information, to sequentially render the battle behavior and the halo (which avoids rendering the halo first without notifying). This makes connection between the battle behavior and the halo smooth and more natural.

Operation 1605: When rendering the battle behavior according to the battle rendering information, the battle control process renders the halo according to the halo rendering information.

When receiving the battle rendering information and the halo rendering information, the battle control process renders the halo according to the halo rendering information in a process of rendering the battle behavior according to the battle rendering information. When only receiving the halo rendering information, the battle control process no longer renders the halo.

In an example, a halo rendering interface is shared by the battle control process and the scene control process. In a turn-based battle (that is, the battle scene), the battle control process calls the halo rendering interface to render the halo according to the halo rendering information. After the turn-based battle ends, the scene control process replaces the battle control process to call the halo rendering interface to complete continued rendering on the halo.

For example, the scene control process renders the halo according to the cached halo rendering information. For example, after the turn-based battle ends, the scene control process calls the halo rendering interface to and render and display remaining halos corresponding to the turn-based battle based on the cached halo rendering information. The remaining halos are halos (for example, rendering on some halos is cancelled in the turn-based battle) that are obtained based on all halo rendering information and that still need to be displayed in a virtual world.

Alternatively, during halo rendering in the battle control process, the scene control process also performs halo statistics according to the cached halo rendering information, and dynamically updates the remaining halos corresponding to the turn-based battle, to seamlessly continue to render and display the remaining halos corresponding to the turn-based battle after the turn-based battle ends.

In an aspect, after the turn-based battle ends, a battle control side may synchronize settlement data of the turn-based battle to a scene control side at a time. For example, after the turn-based battle ends, the first server may synchronize settlement data such as hit point consumption, experience value acquisition, virtual resource consumption, and the like in the turn-based battle to the second server at a time.

In an example, a display occasion and a display position of the halo may be indicated by using a battle rendering label corresponding to the battle behavior. The battle rendering label may include identification information of the turn-based battle, identification information of the battle behavior, identification information of the halo, a position (for example, a land parcel, an affected character, or the like) corresponding to the halo, rendering details of the battle behavior, and the like. The process may specifically include the following:
1. The scene control process receives the battle rendering label from the second server. The battle rendering label is generated by the first server according to the battle behavior when the battle behavior meets triggering of the halo.

When determining that the halo is triggered by the battle behavior, the first server generates the battle rendering label of the battle behavior, generates a call request according to the battle rendering information and the halo information, and sends the call request to the second server in a remote procedure call (RPC) manner. Then, the second server sends the battle rendering label to the scene control process.
2. The scene control process sends the battle rendering label to the battle control process.

After receiving the battle rendering label and the halo rendering information from the second server, the scene control process sends the battle rendering label and the halo rendering information together to the battle control process.
3. Based on the display occasion and the display position indicated by the battle rendering label, the battle control process renders the halo according to the halo rendering information in the process of rendering the battle behavior according to the battle rendering information.

For example, the battle control process determines the display occasion and the display position of the halo according to the rendering details of the battle behavior and the position corresponding to the halo that are in the battle rendering label, and in the process of rendering and displaying the battle behavior, renders and displays the halo at the display position (for example, a target land parcel) when the display occasion is reached. For example, after a cast process of the skill that triggers the halo is rendered, the halo is rendered, to achieve a natural connection between two rendering processes.

In an example, a halo affects a land parcel in the virtual world.

When an initial type of the land parcel is a grass type, the type of the land parcel is transformed into a fire type under the influence of a halo of the fire type, that is, a picture of grass on the land parcel burning is rendered and displayed. Alternatively, when an initial type of the land parcel is a water type, the type of the land parcel is transformed into an ice type under the influence of a halo of the ice type, that is, a picture of water on the land parcel freezing is rendered and displayed. Alternatively, when an initial type of the land parcel is a soil type, the type of the land parcel is transformed into a grass type under the influence of a halo of the grass type, that is, a picture of grass on the land parcel growing is rendered and displayed. This is not limited in this aspect of this disclosure.

In this aspect of this disclosure, when the pet virtual character acts as an attacker, active movement may be caused. When the pet virtual character is an attacked party, passive movement may be generated. When the pet virtual character is attacked by a skill, there may be a knockback process. As the position of the pet virtual character changes, an environment where the pet virtual character is located (including an environment of a land parcel and a weather environment) may also change, which has impact on the battle of the pet virtual character in subsequent rounds. Therefore, in each round of the battle, an environmental affinity (briefly referred to as an affinity, that is, the affinity effect) between the pet virtual character and the virtual world needs to be re-determined. The process may specifically include the following:
1. The battle control process sends a rendering end notification of the battle behavior to the first server.

In an aspect, after completing rendering on the battle behavior and the halo, the battle control process sends the rendering end notification of the battle behavior to the first server. The rendering end notification is configured for informing the first server of completion of rendering on the battle behavior and the halo.

After receiving the rendering end notification, the first server generates an acquisition request for updated environmental information, and sends the acquisition request to the second server to obtain the updated environmental information. After acquiring the updated environmental information, the first server determines, according to the updated environmental information, an affinity between a participant and updated environmental information, where the affinity affects skill strength of the participant. The acquisition request is configured for requesting to obtain the updated environmental information. The acquisition request may include identification information corresponding to the battle behavior, information about the land parcel affected by the halo, and the like. The updated environmental information is environmental information of the battle scene after being affected by the halo, for example, an attribute of the land parcel after being affected by the halo. The first server may obtain updated environmental information corresponding to the halo according to the halo information.
2. The battle control process receives an affinity rendering animation from the first server. The affinity rendering animation is generated by the first server according to the updated environmental information sent by the second server. The updated environmental information is the environmental information of the battle scene after being affected by the halo. The affinity rendering animation is configured for indicating the affinity between the environmental information and the participant, where the affinity affects the skill strength of the participant.

In this aspect of this disclosure, the environmental information may include weather information, land parcel information, and time information. The first server may determine an affinity between the participant and the environment in combination with the environmental information and an attribute of the participant. For example, weather potential energy and land parcel potential energy corresponding to the participant may be obtained, and then the affinity between the participant and the environment is determined based on the weather potential energy and the land parcel potential energy in combination with attribute information of the participant. The weather potential energy may be determined according to the weather information and the time information. For example, a clear sky at night may give a “ghost” potential energy, while a clear sky in the morning may give “light” potential energy. The land parcel potential energy is determined according to a type of a land parcel where the participant is located. For example, the land parcel with the grass attribute has “grass” potential energy.

In an aspect, disgusting and liking of the participants for the environment include the following different levels: strong affinity, weak affinity, indifference, weak conflict, and strong conflict.

If the attribute of the participant matches both the weather potential energy and the land parcel potential energy (that is, the participant likes both the land parcel and the weather), a strong affinity effect is obtained, and the affinity is increased by 2. If the attribute of the participant matches only one of the weather potential energy and the land parcel potential energy, and does not conflict with the other one (that is, the participant only likes one and does not disgust the other one), a relatively weak affinity effect is obtained, and the affinity is increased by 1. If the attribute of the participant matches only one of the weather potential energy and the land parcel potential energy, and conflicts with the other one (that is, the participant only likes one and disgusts the other one), no effect is obtained, and the affinity is increased by 0. If the attribute of the participant conflicts with one of the weather potential energy and the land parcel potential energy, and does not match the other one (that is, the participant only disgusts one and dislikes the other one), a relatively weak conflict effect is obtained, and the affinity is reduced by 1. If the attribute of the participant conflicts with both the weather potential energy and the land parcel potential energy (that is, the participant disgusts both the land parcel and the weather), a strong conflict effect is obtained, and the affinity is reduced by 2.

If the affinity corresponding to the participant is positive, it is considered that environmental affinity for the participant is triggered, and the battle behavior of the participant is enhanced, for example, a range of the skill is enlarged, attack power of the skill is enhanced, an attack effect of the skill is improved, and the like. If the affinity corresponding to the participant is negative, it is considered that the participant is in conflict with the environment, and the battle behavior of the participant is weakened, for example, the range of the skill is reduced, the attack power of the skill is weakened, the attack effect of the skill is degraded, and the like. If the affinity corresponding to the participant is equal to 0, a capability of affecting the battle behavior of the participant is not adjusted.

The first server uses the same method as above to obtain the affinity between the participant and the updated environmental information, to further generate an affinity rendering animation according to the affinity. In an aspect, different affinities correspond to different affinity rendering animations. For example, an affinity rendering animation corresponding to strong affinity is a big smiling face, an affinity rendering animation corresponding to weak affinity is an almost smiling face, and an affinity rendering animation corresponding to strong conflict is an angry face. The affinity rendering animation may be an icon, a dynamic icon, an animation, or the like. This is not limited in this aspect of this disclosure.

The first server delivers the generated affinity rendering animation to the battle control process.
3. The battle control process displays the affinity rendering animation.

After receiving the affinity rendering animation, the battle control process may display the affinity rendering animation near the participant.

Based on the above, in the technical solutions provided in the aspects of this disclosure, the battle rendering information is obtained through implementation of the battle behavior processing logic supported by the battle control process and the first server, and the halo rendering information is obtained through implementation of the halo processing logic supported by the scene control process and the second server, so that there is no need to maintain a piece of battle behavior processing logic and halo processing logic on both the battle control side and the scene control side, and only a piece of scene information needs to be maintained on the scene control side. This reduces redundancy in service logic and data maintenance of the turn-based battle, thereby reducing maintenance overheads.

In addition, by supporting different processes in executing the halo processing logic and the battle behavior processing logic, the halo processing logic and battle behavior processing logic may be decoupled, thereby improving independence of service logic, and reducing the difficulty in maintaining and expanding the turn-based battle. In addition, because underlying code originally belonging to the first server or the second server does not need to be compatible with the first server or the second server, the difficulty of code development is reduced.

Moreover, in the turn-based battle, by supporting the first server to call the halo rendering information from the second server, the scene control process provides the halo rendering information to the battle control process, which realizes information exchange between the battle control side and the scene control side. This enables the battle control side and the scene control side to behave consistently, thereby improving integration between the battle control side and the scene control side.

Furthermore, the display position and the display occasion of the halo are indicated by the battle rendering label, which not only reduces an amount of data transmission, but also enables a natural and smooth connection between the rendering on the battle behavior and the rendering on the halo. This reduces an amount of data transmission in each exchange process, improves a rendering effect of the battle, and synchronizes halo rendering between the battle control side and the scene control side, thereby further improving the integration between the world scene and the battle scene.

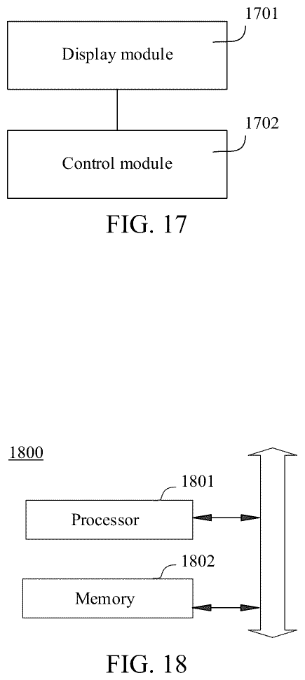

FIG. 17 is a structural block diagram of a turn-based battle interface display apparatus according to an exemplary aspect of this disclosure. The apparatus includes:
a display module 1701, configured to display a scene picture corresponding to a master virtual character located in a world map,
the display module 1701 being further configured to display, in response to a trigger event for a turn-based battle, a scene picture corresponding to a pet virtual character located in a battle map, the pet virtual character being a virtual character released by the master virtual character, and the battle map being a partial map in the world map; and
a control module 1702, configured to control the pet virtual character to cast a virtual skill on the battle map, at least one of skill strength, a skill effect, and a visual effect of the virtual skill being associated with an environmental factor of the battle map.

In an aspect, at least one of the skill strength and the skill effect of the virtual skill is associated with an emotion state of the pet virtual character for the battle map.

In an aspect, the battle map corresponds to at least two environmental factors, the at least two environmental factors being of different types; an affinity effect for indicating that the pet virtual character is in an affinity state is further displayed in the scene picture corresponding to the battle map when a score of environmental factors that the pet virtual character likes among the at least two environmental factors is greater than a score of environmental factors that the pet virtual character disgusts; and a conflict effect for indicating that the pet virtual character is in a conflict state is further displayed in the scene picture corresponding to the battle map when the score of environmental factors that the pet virtual character likes among the at least two environmental factors is less than the score of environmental factors that the pet virtual character disgusts, where skill strength corresponding to the affinity state is higher than skill strength corresponding to the conflict state, and a skill effect corresponding to the affinity state is superior to a skill effect corresponding to the conflict state.

In an aspect, the at least two environmental factors include a first environmental factor and a second environmental factor; a first affinity effect for indicating that the pet virtual character is in a first affinity state is further displayed in the scene picture corresponding to the battle map when the pet virtual character likes both the first environmental factor and the second environmental factor; and a second affinity effect for indicating that the pet virtual character is in a second affinity state is further displayed in the scene picture corresponding to the battle map when the pet virtual character likes the first environmental factor and does not disgust the second environmental factor, where an affinity degree of the first affinity state is higher than an affinity degree of the second affinity state, skill strength corresponding to the first affinity state is higher than skill strength corresponding to the second affinity state, and a skill effect corresponding to the first affinity state is superior to a skill effect corresponding to the second affinity state.

In an aspect, the at least two environmental factors include a first environmental factor and a second environmental factor; a first conflict effect for indicating that the pet virtual character is in a first conflict state is further displayed in the scene picture corresponding to the battle map when the pet virtual character disgusts both the first environmental factor and the second environmental factor; and a second conflict effect for indicating that the pet virtual character is in a second conflict state is further displayed in the scene picture corresponding to the battle map when the pet virtual character disgusts the first environmental factor and dislikes the second environmental factor, where a conflict degree of the first conflict state is higher than a conflict degree of the second conflict state, skill strength corresponding to the first conflict state is lower than skill strength corresponding to the second conflict state, and a skill effect corresponding to the first conflict state is inferior to a skill effect corresponding to the second conflict state.

In an aspect, the first environmental factor is a weather condition or a day/night condition, and the second environmental factor is a surface morphology; or the first environmental factor is a surface morphology, and the second environmental factor is a weather condition or a day/night condition.

In an aspect, when the pet virtual character likes the weather condition, the first environmental factor is the day/night condition, and the second environmental factor is the surface morphology; and when the pet virtual character disgusts the weather condition, the first environmental factor is the weather condition, and the second environmental factor is the surface morphology.

In an aspect, when the pet virtual character likes the weather condition, the first environmental factor is the surface morphology, and the second environmental factor is the day/night condition; and when the pet virtual character disgusts the weather condition, the first environmental factor is the surface morphology, and the second environmental factor is the weather condition.

In an aspect, the visual effect of the virtual skill is obtained by fusing the environmental factor of the battle map and an attribute of a basic virtual skill of the pet virtual character.

In an aspect, the battle map includes at least two land parcels. The visual effect of the virtual skill is obtained by fusing an environmental factor of the land parcel where the pet virtual character is located and the attribute of the basic virtual skill of the pet virtual character; and/or the visual effect of the virtual skill is obtained by fusing an environmental factor of the land parcel where the opponent virtual character is located and the attribute of the basic virtual skill of the pet virtual character, the opponent virtual character being a target virtual character of the virtual skill.

In an aspect, the skill strength of the virtual skill obtained after fusion is higher than skill strength of the basic virtual skill; and/or the skill effect of the virtual skill obtained after fusion is superior to a skill effect of the basic virtual skill.

In an aspect, the battle map includes at least two land parcels. The control module 1702 is further configured to: control the pet virtual character to cast a first virtual skill in a first round, the pet virtual character being located in a first land parcel in the first round; and control the pet virtual character to cast a second virtual skill in a second round, the pet virtual character being located in a second land parcel in the second round, where the first round and the second round are different rounds, and the first land parcel and the second land parcel are different land parcels.

In an aspect, the display module 1701 is further configured to: display a first emotion effect for representing an emotion state of the pet virtual character for the land parcel where the pet virtual character is located; and display a second emotion effect for representing an emotion state of the pet virtual character for the land parcel where the pet virtual character is located.

In an aspect, the control module 1702 is further configured to: obtain an environmental factor of the first land parcel; and fuse the first virtual skill according to the environmental factor of the first land parcel and an attribute of a basic virtual skill of the pet virtual character; and obtain an environmental factor of the second land parcel; and fuse the second virtual skill according to the environmental factor of the second land parcel and the attribute of the basic virtual skill of the pet virtual character.

In an aspect, the control module 1702 is further configured to: obtain an environmental factor of a third land parcel; and fuse the first virtual skill according to the environmental factor of the first land parcel and an attribute of a basic virtual skill of the pet virtual character, the third land parcel being a land parcel where an opponent virtual character is located in the first round; obtain an environmental factor of a fourth land parcel; and fuse the second virtual skill according to the environmental factor of the second land parcel and the attribute of the basic virtual skill of the pet virtual character, the fourth land parcel being a land parcel where the opponent virtual character is located in the second round.

In an aspect, the environmental factor of the battle map is associated with a battle status in a combat process of the turn-based battle.

In an aspect, the display module 1701 is further configured to: display battle traces in the partial map in the world map after the turn-based battle ends.

In an aspect, the display module 1701 is further configured to: during the turn-based battle, change the environmental factor of the battle map when an environmental factor of the partial map changes.

In an aspect, the display module 1701 is further configured to: change a j^{th} environmental factor of the battle map when an i^{th} environmental factor of the partial map changes, where the i^{th} environmental factor is any one of a weather condition, a day/night condition, and a surface morphology; and the j^{th} environmental factor is any one of the weather condition, the day/night condition, and the surface morphology, both i and j being positive integers.

In an aspect, the display module 1701 is further configured to: during the turn-based battle, change an environmental factor of the partial map when the environmental factor of the battle map changes.

In an aspect, the display module 1701 is further configured to: an n^{th} environmental factor of the battle map is changed when an m^{th} environmental factor of the partial map changes, where the m^{th} environmental factor is any one of a weather condition, a day/night condition, and a surface morphology; and the n^{th} environmental factor is any one of the weather condition, the day/night condition, and the surface morphology, both m and n being positive integers.

FIG. 18 shows a structural block diagram of a terminal device 1800 according to an exemplary aspect of this disclosure. The terminal device 1800 may be a portable mobile terminal, for example, a smartphone, a tablet computer, a Moving Picture Experts Group Audio Layer III (MP3) player, a Moving Picture Experts Group Audio Layer IV (MP4) player, a notebook computer, or a desktop computer. The terminal device 1800 may also be referred to as user equipment, a portable terminal, a laptop terminal, a desktop terminal, or by another name.

Generally, the terminal device 1800 includes a processor 1801 and a memory 1802.

Processing circuitry, such as the processor 1801 may include one or more processing cores, for example, a 4-core processor or an 8-core processor. The processor 1801 may be implemented in at least one hardware form of a digital signal processor (DSP), a field-programmable gate array (FPGA), and a programmable logic array (PLA). The processor 1801 may alternatively include a main processor and a coprocessor. The main processor is configured to process data in an awake state, also referred to as a central processing unit (CPU). The coprocessor is a low-power processor configured to process data in a standby state. In some aspects, the processor 1801 may be integrated with a graphics processing unit (GPU). The GPU is configured to render and draw content that needs to be displayed on a display. In some aspects, the processor 1801 may further include an artificial intelligence (AI) processor. The AI processor is configured to process a computing operation related to machine learning.

The memory 1802 may include one or more computer-readable storage medium, such as a non-transitory computer-readable storage medium. The memory 1802 may further include a high-speed random access memory, and a non-volatile memory such as one or more magnetic disk storage devices and a flash memory device. In some aspects, a non-transitory computer-readable storage medium in the memory 1802 is configured to store at least one instruction, the at least one instruction being configured to be executed by the processor 1801 to implement the turn-based battle interface display method provided in the method aspects of this disclosure.

A person skilled in the art may understand that the structure shown in FIG. 18 does not constitute a limitation to the terminal device 1800, and the electronic device may include more components or fewer components than those shown in the figure, or some components may be combined, or a different component deployment may be used.

This disclosure further provides a computer-readable storage medium, having at least one program stored therein, the at least one program being loaded and executed by a processor to implement the turn-based battle interface display method provided in the foregoing aspects.

This disclosure further provides a computer program product. The computer program product includes computer instructions, and the computer instructions are stored in a computer-readable storage medium. A processor of a computer device reads the computer instructions from the computer-readable storage medium, and executes the computer instructions, to cause the computer device to perform the turn-based battle interface display method provided in the foregoing method aspects.

The sequence numbers of the foregoing aspects of this disclosure are merely for description purpose but do not imply the preference among the aspects.

A person of ordinary skill in the art may understand that all or some of the operations of the foregoing aspects may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely examples of aspects of this disclosure and are not intended to limit this disclosure. A person skilled in the art can make some equivalent variations, alterations or modifications to the above-disclosed technical content without departing from the scope of the technical solutions of this disclosure to obtain equivalent examples. Other aspects, including variations of the aspects described herein, shall fall within the scope of the technical solutions of this disclosure.

What is claimed is:

1. A turn-based battle interface display method, the method comprising:
displaying, by processing circuitry, a first scene picture corresponding to a master virtual character located in a world environment;
displaying, in response to a trigger event for a turn-based battle, a second scene picture corresponding to a pet virtual character located in a battle environment, the pet virtual character being a virtual character released by the master virtual character, and the battle environment being a partial environment of the world environment; and
controlling the pet virtual character to cast a virtual skill on the battle environment, at least one of skill strength, a skill effect, or a visual effect of the virtual skill being associated with an environmental factor of the battle environment.

2. The method according to claim 1, wherein the at least one of the skill strength or the skill effect of the virtual skill is associated with an emotion state of the pet virtual character.

3. The method according to claim 2, wherein the battle environment includes at least two environmental factors, the at least two environmental factors being different types, and the battle environment further comprises:
an affinity effect for indicating that the pet virtual character is in an affinity state when a score of environmental factors that the pet virtual character likes is greater than a score of environmental factors that the pet virtual character dislikes; and
a conflict effect for indicating that the pet virtual character is in a conflict state when the score of environmental factors that the pet virtual character likes is less than the score of environmental factors that the pet virtual character dislikes, the skill strength in the affinity state is higher than the conflict state, and the skill effect in the affinity state is higher than the conflict state.

4. The method according to claim 3, wherein the at least two environmental factors include a first environmental factor and a second environmental factor, and further comprises:
displaying a first affinity effect for indicating that the pet virtual character is in a first affinity state when the pet virtual character likes both the first environmental factor and the second environmental factor; and
displaying a second affinity effect for indicating that the pet virtual character is in a second affinity state when the pet virtual character likes the first environmental factor and dislikes the second environmental factor, wherein an affinity degree of the first affinity state is higher than the second affinity state, the skill strength corresponding to the first affinity state is higher the second affinity state, and the skill effect corresponding to the first affinity state is higher than the second affinity state.

5. The method according to claim 4, wherein
the first environmental factor is a weather condition or a day/night condition, and the second environmental factor is a surface morphology; or
the first environmental factor is a surface morphology, and the second environmental factor is a weather condition or a day/night condition.

6. The method according to claim 5, wherein
that the first environmental factor is a weather condition or a day/night condition,
the second environmental factor is a surface morphology,
when the pet virtual character likes the weather condition, the first environmental factor is the day/night condition, and the second environmental factor is the surface morphology; and
when the pet virtual character dislikes the weather condition, the first environmental factor is the weather condition, and the second environmental factor is the surface morphology.

7. The method according to claim 5, wherein
the first environmental factor is a surface morphology,
the second environmental factor is a weather condition or a day/night condition,
when the pet virtual character likes the weather condition, the first environmental factor is the surface morphology, and the second environmental factor is the day/night condition; and
when the pet virtual character dislikes the weather condition, the first environmental factor is the surface morphology, and the second environmental factor is the weather condition.

8. The method according to claim 1, further comprises:
controlling the pet virtual character to cast a first virtual skill in a first turn, the pet virtual character being located in a first land parcel in the first turn; and
controlling the pet virtual character to cast a second virtual skill in a second turn, the pet virtual character being located in a second land parcel in the second turn, wherein the first turn and the second turn are different turns, and the first land parcel and the second land parcel are different land parcels.

9. The method according to claim 8, further comprising:
displaying a first emotion effect for representing an emotion state of the pet virtual character for the first land parcel; and
displaying a second emotion effect for representing an emotion state of the pet virtual character for the second land parcel.

10. The method according to claim 8, further comprising:
obtaining an environmental factor of the first land parcel, fusing the first virtual skill according to the environmental factor of the first land parcel and an attribute of a basic virtual skill of the pet virtual character; and
obtaining an environmental factor of the second land parcel, fusing the second virtual skill according to the environmental factor of the second land parcel and the attribute of the basic virtual skill of the pet virtual character.

11. The method according to claim 8, further comprising:
obtaining an environmental factor of a third land parcel, fusing the first virtual skill according to the environmental factor of the third land parcel and an attribute of a basic virtual skill of the pet virtual character, the third land parcel being a land parcel where an opponent virtual character is located in the first turn; and
obtaining an environmental factor of a fourth land parcel, fusing the second virtual skill according to the environmental factor of the fourth land parcel and the attribute of the basic virtual skill of the pet virtual character, the fourth land parcel being a land parcel where the opponent virtual character is located in the second turn.

12. The method according to claim 1, wherein the environmental factor of the battle environment is associated with a battle status in a combat process of the turn-based battle.

13. The method according to claim 1, further comprising:
displaying battle traces in the partial environment of the world environment after the turn-based battle ends.

14. The method according to claim 1, further comprising:
during the turn-based battle, changing the environmental factor of the battle environment when an environmental factor of the partial environment changes.

15. A turn-based battle interface display apparatus, comprising:
processing circuitry configured to:
display a first scene picture corresponding to a master virtual character located in a world environment;
display, in response to a trigger event for a turn-based battle, a second scene picture corresponding to a pet virtual character located in a battle environment, the pet virtual character being a virtual character released by the master virtual character, and the battle environment being a partial environment of the world environment; and
control the pet virtual character to cast a virtual skill on the battle environment, at least one of skill strength, a skill effect, or a visual effect of the virtual skill being associated with an environmental factor of the battle environment.

16. The apparatus according to claim 15, wherein the at least one of the skill strength or the skill effect of the virtual skill is associated with an emotion state of the pet virtual character.

17. The apparatus according to claim 16, wherein
the battle environment includes at least two environmental factors,
the at least two environmental factors are different types, and the battle environment further comprises:
an affinity effect for indicating that the pet virtual character is in an affinity state when a score of environmental factors that the pet virtual character likes is greater than a score of environmental factors that the pet virtual character dislikes; and
a conflict effect for indicating that the pet virtual character is in a conflict state when the score of environmental factors that the pet virtual character likes is less than the score of environmental factors that the pet virtual character dislikes, the skill strength in the affinity state being higher than the conflict state, and the skill effect in the affinity state being higher than the conflict state.

18. A non-transitory computer-readable storage medium, storing instructions which when executed by a processor cause the processor to perform:
displaying a first scene picture corresponding to a master virtual character located in a world environment;
displaying, in response to a trigger event for a turn-based battle, a second scene picture corresponding to a pet virtual character located in a battle environment, the pet virtual character being a virtual character released by the master virtual character, and the battle environment being a partial environment of the world environment; and
controlling the pet virtual character to cast a virtual skill on the battle environment, at least one of skill strength, a skill effect, or a visual effect of the virtual skill being associated with an environmental factor of the battle environment.

19. The non-transitory computer-readable storage medium according to claim 18, wherein the at least one of the skill strength or the skill effect of the virtual skill is associated with an emotion state of the pet virtual character.

20. The non-transitory computer-readable storage medium according to claim 19, wherein the battle environment includes at least two environmental factors, the at least two environmental factors being different types, and the battle environment further comprises:
an affinity effect for indicating that the pet virtual character is in an affinity state when a score of environmental factors that the pet virtual character likes is greater than a score of environmental factors that the pet virtual character dislikes; and
a conflict effect for indicating that the pet virtual character is in a conflict state when the score of environmental factors that the pet virtual character likes is less than the score of environmental factors that the pet virtual character dislikes, wherein skill strength in the affinity state is higher than the conflict state, and skill effect in the affinity state is higher than the conflict state.
